(19) United States
(12) Patent Application Publication
(10) Pub. No.: US 2024/0117856 A1
(43) Pub. Date: Apr. 11, 2024

(54) MULTI-DEGREE VIBRATION ISOLATION UNIT

(71) Applicant: City University of Hong Kong, Kowloon (HK)

(72) Inventor: Xingjian Jing, Sha Tin (HK)

(21) Appl. No.: 17/954,501

(22) Filed: Sep. 28, 2022

(51) Int. Cl. F16F 15/067; F16M 11/22

(52) U.S. Cl. CPC F16F 15/067; F16M 11/22

(57) ABSTRACT

Vibration isolation units are provided for vibration suppression in multiple directions. The vibration isolation units may have an X-shaped structure as part of its support structure. The vibration isolation units can work for ultra-low frequency vibration isolation in three directions in a passive manner. The vibration isolation units can achieve a flexible nonlinear stiffness, which contains zero or quasi-zero stiffness, negative stiffness and positive stiffness. A smooth multi-equilibria state is also achievable. Compared with traditional spring-mass-damper (SMD) and typical QZS systems, the provided vibration isolation units can have an enhanced QZS range of larger stroke with guaranteed loading capacity, and can also achieve a lower resonant frequency with a lower resonant peak. At least some embodiments of the vibration isolation units may include a new and innovative arrangement of components that enables the use of only four supporting members.

### TECHNICAL FIELD

The present application relates generally to vibration isolation structures. More specifically, the present application relates to quasi-zero stiffness (QZS) vibration isolators.

### BACKGROUND

Vibration problems are often considered a negative factor in many engineering systems. Detrimental vibrations may significantly affect the accuracy of precision equipment, reduce service life of instruments, and cause structural fatigue damage. As such, the unwanted vibrations need to be controlled within a rational and acceptable range in engineering systems. Various vibration suppression systems attempt to address this issue, such as traditional linear passive vibration isolators, active/semi-active isolation elements, and nonlinear quasi-zero stiffness (QZS) passive isolators, though each have their own drawbacks.

Traditional linear vibration isolators can only suppress structural vibration with excitation frequency larger than \sqrt{2} times of the natural frequency, which makes it difficult to achieve low-frequency vibration isolation. Active or semi-active isolation elements often need additional active actuators and controllers, causing considerable energy inputs and increasing the complexity of vibration isolation systems. Many typical nonlinear QZS passive isolators are designed to attenuate the transmission of a single vertical vibration. With performance improvement in high precision manufacturing and measuring equipment, however, external excitations often distribute in more than a single direction, and therefore multi-direction low-frequency isolation with high efficiency is needed for attenuating transmission of multi-direction vibrations. There remains room for improvement with respect to typical nonlinear QZS passive isolators having multiple degrees of freedom.

### SUMMARY

The present disclosure provides new and innovative vibration isolation units for vibration suppression in multiple directions. The provided vibration isolation units may include a passive X-shaped mechanism for vibration suppression. The included passive X-shaped mechanism may have less bars than typical vibration isolation units having an X-shaped mechanism and can therefore be more compact than such typical vibration isolation units. In at least some aspects of the vibration isolation units, a vibration isolation unit does not include a guiding slider for motion restriction, which helps reduce friction generated by motion of the vibration isolation unit. At least some of the vibration isolation units disclosed herein may include a new and innovative component arrangement. This component arrangement may enable more flexible usage of the X-shaped mechanism for vibration suppression than typical vibration isolation units including an X-shaped mechanism. For instance, combining two or more of the provided vibration isolation units, and/or restricting the motion of the vibration suppression mechanism in one or more directions, can achieve various degrees-of-freedom of vibration isolation (e.g., 1, 2, 3, 4, 5, or 6 degrees-of-freedom).

In an example, a vibration isolation unit includes a first base member, a second base member, a first support member, a second support member, a third support member, and a fourth support member. The first support member may be rotatably connected to the first base member at a first joint. The second support member may be rotatably connected to the first base member at a second joint, and crosses over the first support member at a first crossover point. The third support member may be rotatably connected to the second base member at a third joint and to the first support member at a fourth joint. The fourth support member may be rotatably connected to the second base member at a fifth joint and to the second support member at a sixth joint, and crosses over the third support member at a second crossover point.

In another example, a vibration isolation unit includes a first X-shaped support structure including a first support member and a second support member, and a second X-shaped support structure including a third support member and a fourth support member. The first X-shaped support structure is connected to the second X-shaped support structure at first and second rotation joints. The example vibration isolation unit further includes first, second, and third resilient members. The first resilient member is connected to each of the first and second rotation joints. The second resilient member connects the second support member to the third support member. The third resilient member connects the first support member to the fourth support member.

Additional features and advantages of the disclosed method and apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

FIG. 1 illustrates a perspective view of a vibration isolation unit, according to an aspect of the present disclosure.

FIG. 2 illustrates a side view of the vibration isolation unit of FIG. 1, according to an aspect of the present disclosure.

FIG. 3 illustrates a front view of the vibration isolation unit of FIG. 1, according to an aspect of the present disclosure.

FIG. 4 illustrates a perspective view of the vibration isolation unit of FIG. 1 in an expanded state, according to an aspect of the present disclosure.

FIG. 5 illustrates a schematic representation of the vibration isolation unit of FIG. 1, according to an aspect of the present disclosure.

FIG. 6 illustrates a schematic representation of the vibration isolation unit of FIG. 1, according to an aspect of the present disclosure.

FIG. 7 illustrates schematic force diagrams of select components of the vibration isolation unit of FIG. 1, according to an aspect of the present disclosure.

FIG. 8 illustrates a schematic representation of the vibration isolation unit of FIG. 1, according to an aspect of the present disclosure.

FIG. 9 shows nonlinear force-displacement curves of the vibration isolation unit under different spring stiffness, according to an aspect of the present disclosure.

FIG. 10 shows nonlinear force-displacement curves of the vibration isolation unit under (a) different lengths L₂, (b) different lengths L₄, (c) different parameters α and (d) different parameters β, according to an aspect of the present disclosure.

FIG. 11 shows bending moment and rotation angle curves of the vibration isolation unit under (a) different spring stiffness kᵤ and (b) different spring stiffness kₗ, according to an aspect of the present disclosure.

FIG. 12 shows bending moment and rotation angle curves of the vibration isolation unit under (a) different lengths L₂, (b) different lengths L₄, (c) different parameters α and (d) different parameters β, according to an aspect of the present disclosure.

FIG. 13 shows nonlinear force-displacement curves of the vibration isolation unit under (a) different spring stiffness kᵤ and (b) different spring stiffness kₗ, according to an aspect of the present disclosure.

FIG. 14 shows nonlinear force-displacement curves of the vibration isolation unit under (a) different lengths L₂, (b) different lengths L₄, (c) different parameters α and (d) different parameters β, according to an aspect of the present disclosure.

FIG. 15 shows nonlinear force-displacement curves of the vibration isolation unit under (a) different spring stiffness kₗ, (b) different spring stiffness kₘ, (c) different parameters α and (d) different parameters β, according to an aspect of the present disclosure.

FIG. 16 shows the (a) nonlinear force-displacement relationship curve and (b) displacement transmissibility of the vibration isolation unit in the x-direction under different equilibrium positions, according to an aspect of the present disclosure.

FIG. 17 is a table of coefficient values of the polynomials used for fitting the stiffness and damping characteristics of the vibration isolation unit, according to an aspect of the present disclosure.

FIG. 18 shows the (a) nonlinear bending moment and rotation angle curve and (b) displacement transmissibility of the vibration isolation unit in the ψ-direction under different equilibrium positions, according to an aspect of the present disclosure.

FIG. 19 shows the (a) nonlinear force-displacement relationship curve and (b) displacement transmissibility of the vibration isolation unit in the vertical direction under different equilibrium positions, according to an aspect of the present disclosure.

FIG. 20 shows graphs of (a) variations of the isolated mass with equilibrium position and (b) absolute displacement transmissibility of the vibration isolation unit in vertical direction under different kₗ, according to an aspect of the present disclosure.

FIG. 21 shows graphs of (a) variations of the isolated mass with equilibrium position and (b) absolute displacement transmissibility of the vibration isolation unit in the vertical direction under different β, according to an aspect of the present disclosure.

FIG. 22 shows graphs of absolute displacement transmissibility of the vibration isolation unit in the horizontal, the rotational and the vertical directions with (a) different kᵤ and (b) different kₗ, according to an aspect of the present disclosure.

FIG. 23 shows graphs of absolute displacement transmissibility of the vibration isolation unit in the horizontal, the rotational and the vertical directions with (a) different L₂ and (b) different L₄, according to an aspect of the present disclosure.

FIG. 24 shows graphs of absolute displacement transmissibility of the vibration isolation unit in the horizontal, the rotational and the vertical directions with (a) different α and (b) different β, according to an aspect of the present disclosure.

FIG. 25 shows graphs of vibration isolation performance of the vibration isolation unit in (a) the horizontal direction, (b) the rotational direction and (c) the vertical direction under different base excitation amplitudes, according to an aspect of the present disclosure.

FIG. 26 shows graphs of vibration isolation performance of the vibration isolation unit in (a) the horizontal direction, (b) the rotational direction and (c) the vertical direction under different damping coefficients, according to an aspect of the present disclosure.

FIG. 27 shows graphs of harmonic excitation and response of the vibration isolation unit in the vertical direction, according to an aspect of the present disclosure.

FIG. 28 shows nonlinear force-displacement relationship curves and displacement transmissibility of the vibration isolation unit in (b) the horizontal direction, (c) the rotational direction and (d) the vertical direction, according to an aspect of the present disclosure.

### DETAILED DESCRIPTION

New and innovative vibration isolation units are provided for vibration suppression in multiple directions. The vibration isolation units may have an X-shaped structure as part of its support structure. For instance, an embodiment of the vibration isolation unit may include two support members (e.g., rods) that cross over one another to form a first X-shape and two other support members that cross over one another to form a second X-shape. The support members of the first X-shape may be rotatably connected to the support members of the second X-shape. It has been shown that X-shaped structures provide beneficial nonlinear effects brought by nonlinear inertia, nonlinear damping, and nonlinear stiffness.

The vibration isolation units may include at least one resilient member (e.g., spring) connected to its support members. In some examples, the vibration isolation unit includes an arrangement of three resilient members. In other examples, the vibration isolation unit includes an arrangement of five resilient members.

The vibration isolation units can work for ultra-low frequency vibration isolation in three directions in a passive manner. The vibration isolation units can achieve a flexible nonlinear stiffness, which contains zero or quasi-zero stiffness, negative stiffness and positive stiffness. A smooth multi-equilibria state is also achievable. Compared with traditional spring-mass-damper (SMD) and typical QZS systems, the provided vibration isolation units can have an enhanced QZS range of larger stroke with guaranteed loading capacity, and can also achieve a lower resonant frequency with a lower resonant peak. The QZS characteristics of the vibration isolation units with high loading capacity and large stroke can be achieved, not only in the vertical direction, but also in the horizontal and rotational directions, with a guaranteed stable equilibrium due to the flexibility of the vibration isolation units' design.

At least some embodiments of the vibration isolation unit may include a new and innovative arrangement of components that enables the use of only four supporting members (e.g., rods). The arrangement may, additionally or alternatively, enable the vibration isolation unit to not include a guiding slider for motion restriction, which helps reduce friction generated by motion of the vibration isolation unit. The new and innovative arrangement can therefore lead to a more compact design than typical vibration isolation systems.

Embodiments of the vibration isolation unit may be used in a variety of applications, such as remote sensing satellites, aviation seat frames, medical or cargo transportation, suspension systems of the vehicle, etc. For example, remote sensing satellites require highly quiet environments to protect sensitive payloads including astronomical telescopes, laser communication equipment, and micro-gravity experimental devices. In the design of satellite control systems, one of the most important factors is the vibration isolation between the precision payload and the disturbance base, in which a wider isolation frequency range including low frequency and high frequency with high effectiveness is desired to reduce vibration transmission from multiple vibration environments such as noise, solar radiation pressure and aerodynamic disturbance. Most typical vibration control systems are too complicated to switch from different stiffness modes or require high power cost, which reduces their reliability and restricts their applications on unmanned satellites. Embodiments of the provided vibration isolation unit, however, enable tuning the unit's stiffness to control vibration transmissibility and achieve ultra-low frequency vibration isolation in several directions such that it may be used between the precision payload and the disturbance base in satellites.

In another example, heavy-duty commercial vehicles and their cargo are usually subjected to mechanical vibrations and shocks from the ground. The vibration transmitted from different directions and different ranges may cause damage to the cargo (e.g., fragile ceramics and high-precision instruments). Additionally, most commercial vehicle drivers are prone to long-term exposure to low-frequency vibrations (e.g., from 1 Hz to 20 Hz) caused by road surface excitations, which can result in diseases of muscles, digestive systems and even visual systems. Embodiments of the vibration isolation unit may be structured to provide vibration isolation for either of these applications.

In any of the embodiments of the vibration isolation unit, the various parameters of the vibration isolation unit (e.g., rod segment lengths, spring stiffness, initial assembly angles, spring connection parameters, etc.) can be selected to flexibly meet various requirements of the different applications of the vibration isolation unit. For instance, different applications of the vibration isolation unit can have their own specific requirements, such as a working displacement range, a height of the vibration isolation unit, and/or a payload and frequency range of external excitation. In an example, initial assembly angles can be selected, and then by combining the selected initial assembly angles with a desired height of the working environment of the vibration isolation unit, the rod segment lengths can be determined. In another example, the stiffness parameters of the springs in the vibration isolation unit can be determined by adjusting the spring stiffness until the vibration isolation unit satisfies the requirements of the desired payload and working displacement range. In another example still, the rod segment lengths and spring connection parameters can be adjusted to obtain a desired loading capacity and QZS zone requirements.

Joints that facilitate rotation of two connected components with respect to one another are described herein. Any suitable joint that connects two components and enables such movement may be used. For example, a bar positioned through respective openings in each of the two components is one such suitable joint.

As used herein, a resilient member is an elastic component that repeatedly stores and releases mechanical energy. For example, a resilient member may be any suitable spring (e.g., coil spring, extension/tension spring, machined spring, etc.).

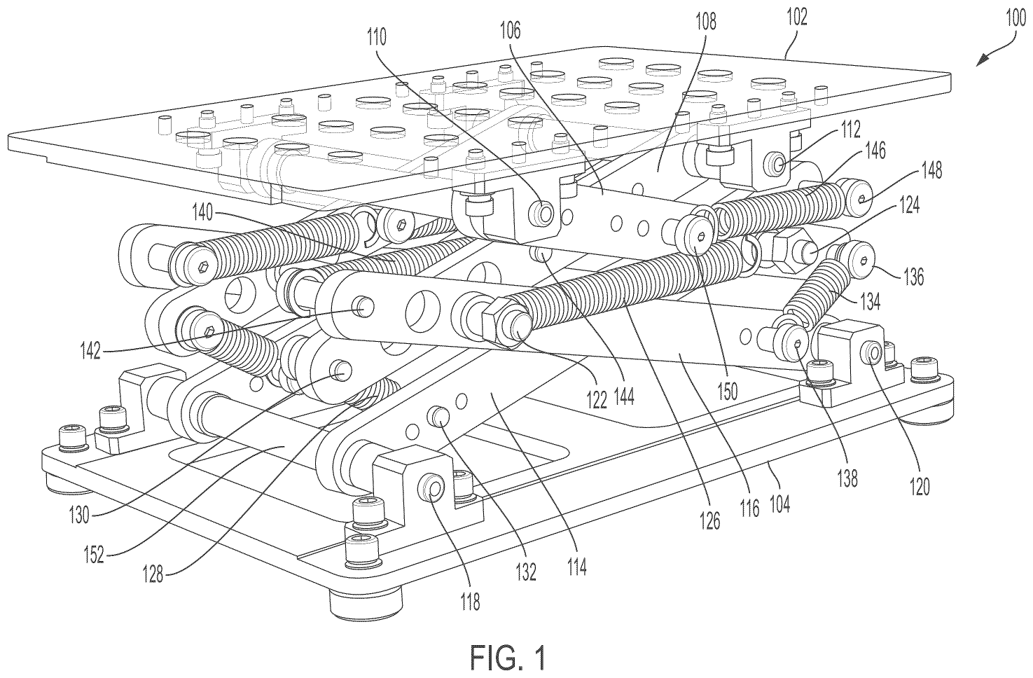

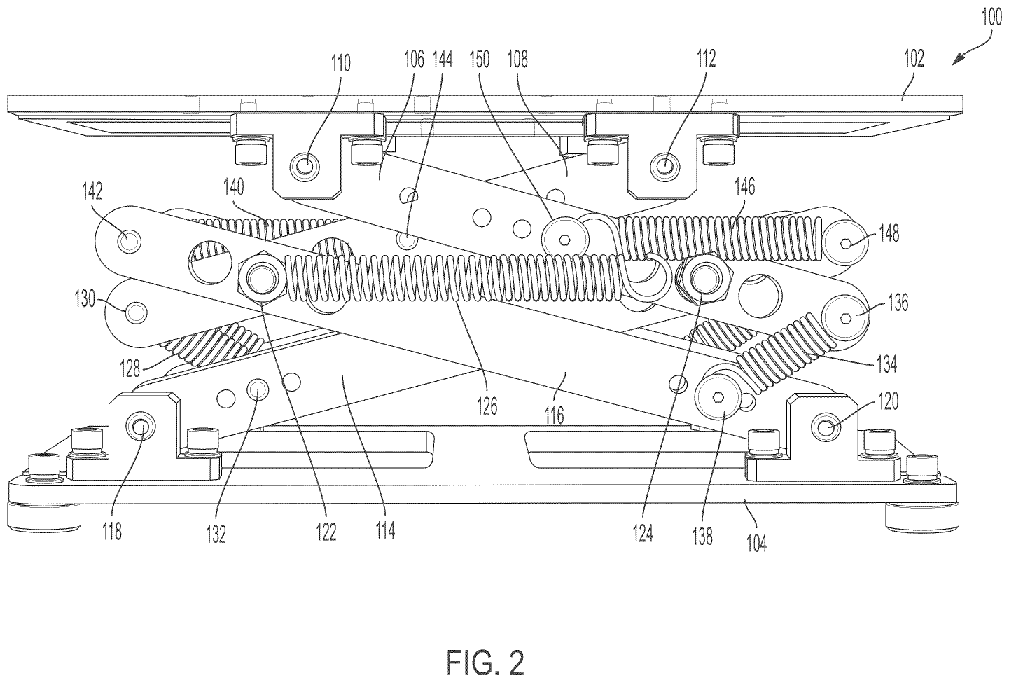

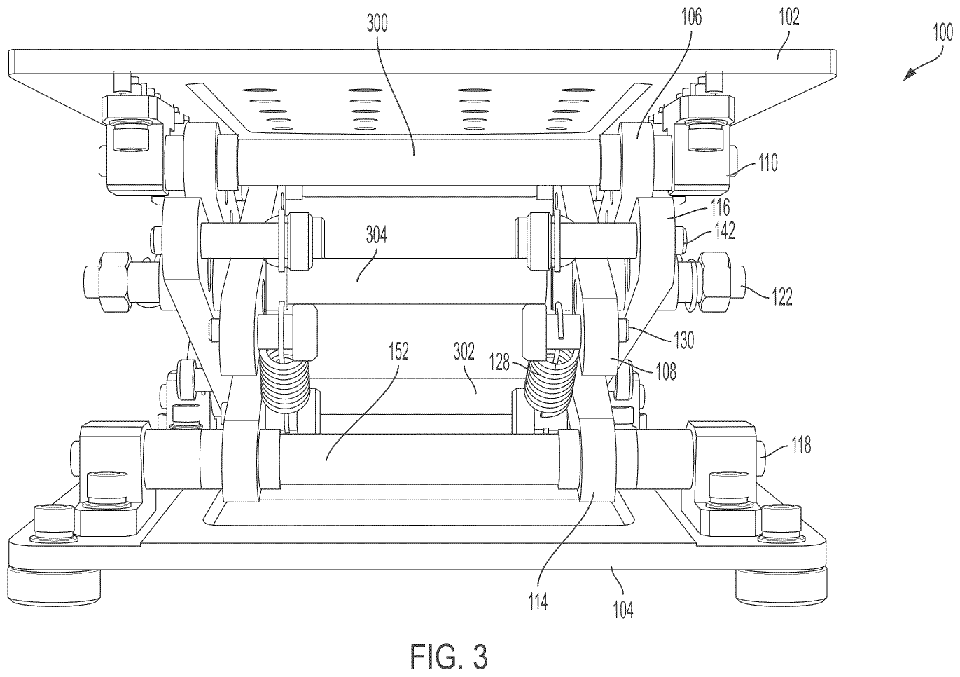

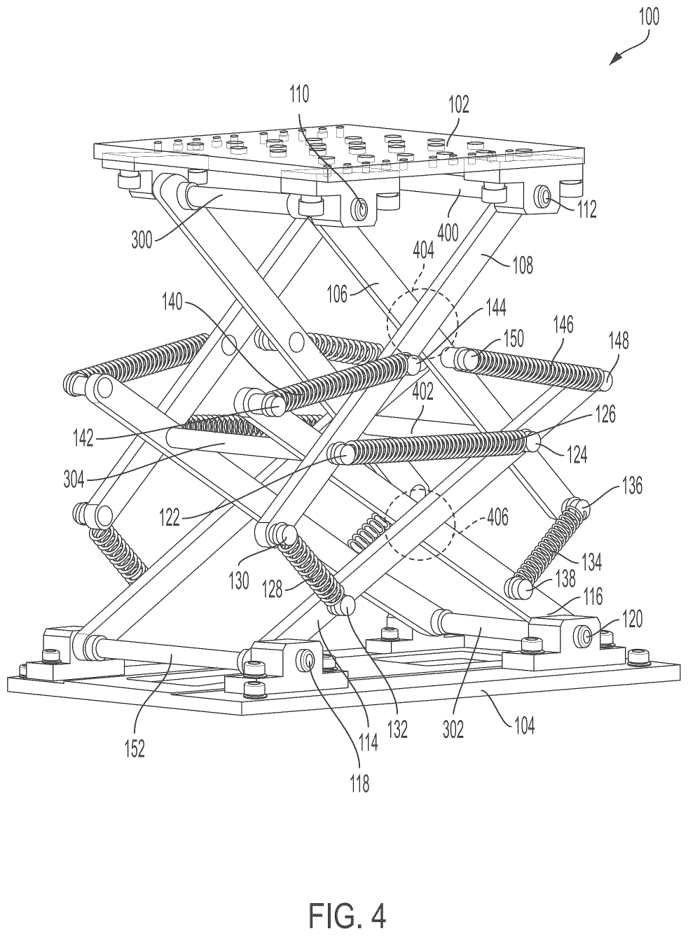

FIGS. 1 to 4 illustrate views of an example vibration isolation unit 100. The vibration isolation unit 100 may include a first base member 102 and/or a second base member 104. A first support member 106 may be rotatably connected to the first base member 102 at a joint 110. A second support member 108 may be rotatably connected to the first base member 102 at a joint 112. A third support member 114 may be rotatably connected to the second base member 104 at a joint 118. A fourth support member 116 may be rotatably connected to the second base member 104 at a joint 120. In at least some examples, each of the support members 106, 108, 114, and 116 may be a rod having any suitable cross-section (e.g., circular, rectangular, etc.).

In at least some aspects, the first support member 106 may be rotatably connected to the third support member 114 at a joint 124, and the second support member 108 may be rotatably connected to the fourth support member 116 at a joint 122. In this example arrangement, the first support member 106 crosses over the second support member 108 at a crossover point 404 to thereby form an X-shape. In at least some aspects, the first support member 106 does not contact the second support member 108 at the crossover point 404. The third support member 114 likewise crosses over the fourth support member 116 at a crossover point 406 to thereby form an X-shape. In at least some aspects, the third support member 114 does not contact the fourth support member 116 at the crossover point 406. In various aspects, the first support member 106 may cross over the third support member 114 at the joint 124 to thereby form an X-shape. In various aspects, the second support member 108 may cross over the fourth support member 116 at the joint 122 to thereby form an X-shape.

The vibration isolation unit 100 may include a first resilient member 126. One end of the first resilient member 126 may be connected at the joint 122. The other end of the first resilient member 126 may be connected at the joint 124. In some aspects, the vibration isolation unit 100 may include a second resilient member 128. In such aspects, one end of the second resilient member 128 may be connected to the second support member 108 at a joint 130. In at least some examples, the joint 130 may be positioned at an end of the second support member 108. The other end of the second resilient member 128 may be connected to the third support member 114 at a joint 132. As in the illustrated example, the joint 132 may be positioned on the third support member 114 between the joint 118 and the crossover point 406.

In some aspects, the vibration isolation unit 100 may include a third resilient member 134. In such aspects, one end of the third resilient member 134 may be connected to the first support member 106 at a joint 136. In at least some examples, the joint 136 may be positioned at an end of the first support member 106. The other end of the third resilient member 134 may be connected to the fourth support member 116 at a joint 138. As in the illustrated example, the joint 138 may be positioned on the fourth support member 116 between the joint 120 and the crossover point 406.

In some aspects, the vibration isolation unit 100 may include a fourth resilient member 140. In such aspects, one end of the fourth resilient member 140 may be connected to the fourth support member 116 at a joint 142. In at least some examples, the joint 142 may be positioned at an end of the fourth support member 116. The other end of the fourth resilient member 140 may be connected to the second support member 108 at a joint 144. As in the illustrated example, the joint 144 may be positioned on the second support member 108 between the joint 122 and the crossover point 404.

In some aspects, the vibration isolation unit 100 may include a fifth resilient member 146. In such aspects, one end of the fifth resilient member 146 may be connected to the third support member 114 at a joint 148. In at least some examples, the joint 148 may be positioned at an end of the third support member 114. The other end of the fifth resilient member 146 may be connected to the first support member 106 at a joint 150. As in the illustrated example, the joint 150 may be positioned on the third support member 114 between the joint 124 and the crossover point 404.

While only one side of the vibration isolation unit 100 is described in the preceding description, it will be appreciated that the opposing side of the vibration isolation unit 100 may be a mirror image of the described side. In at least some aspects, one or more support bars may extend between the sides to provide stability and/or support to the vibration isolation unit 100. For example, a support bar 152 may extend from the joint 118. A support bar 300 may extend from the joint 110. A support bar 302 may extend from the joint 120. A support bar 304 may extend from the joint 122. A support bar 400 may extend from the joint 112. A support bar 402 may extend from the joint 124.

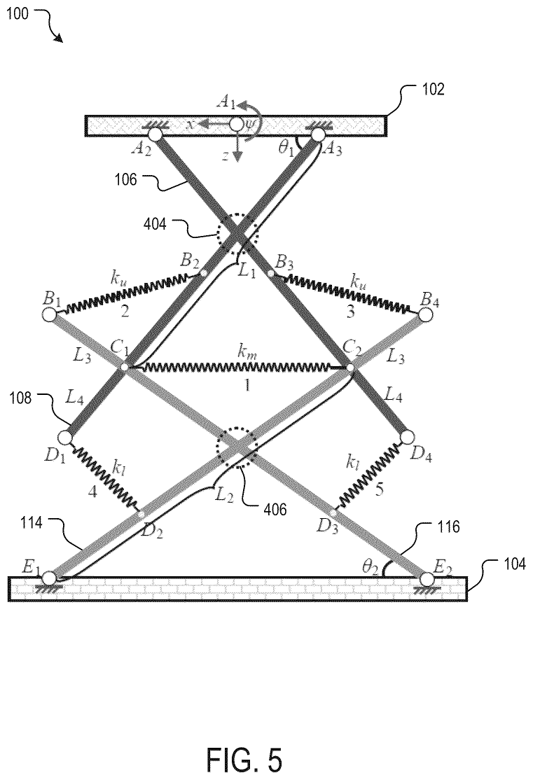

In various aspects, the vibration isolation unit 100 may have three degrees-of-freedom. For example, the three axes (e.g., horizontal, vertical, and rotational) on which the vibration isolation unit 100 may move in such aspects are shown in FIG. 5. In some aspects, the vibration isolation unit 100 may have two degrees-of-freedom. For example, if one of the movement of the horizontal or the rotational direction is restricted, a vibration isolation unit 100 having two degrees-of-freedom can be achieved. In some aspects, the vibration isolation unit 100 may have one degree-of-freedom. For example, if both of the movement of the horizontal and the rotational direction is restricted, a vibration isolation unit 100 having one degree-of-freedom can be achieved. In various aspects, two or more vibration isolation units 100 may be combined to achieve a vibration isolation system having more than three degrees-of-freedom (e.g., four, five, or six degrees-of-freedom). For instance, one or both of the combined vibration isolation units 100 may be restricted as described above to achieve four or five degrees-of-freedom, or neither may be restricted to achieve six degrees-of-freedom.

The following description provides a mechanical model and equations of motion of an example vibration isolation unit 100 as well as various parameter and performance analyses. In the following, each of the resilient members 126, 128, 134, 140, and 146 is referred to as a spring. Specifically, the resilient member 126 is referred to as spring “1”, the resilient member 140 as spring “2”, the resilient member 146 as spring “3”, the resilient member 128 as spring “4”, and the resilient member 134 as spring “5”. As described above, however, each of the resilient members 126, 128, 134, 140, and 146 may be a suitable resilient component other than a spring. Additionally, each of the support members 106, 108, 114, and 116 may be referred to as a rod in the following exemplary description. Specifically, the support member 106 may be referred to as rod A₂D₄, the support member 108 may be referred to as rod D₁ A₃, the support member 114 may be referred to as rod E₁B₄, and the support member 116 may be referred to as rod B₁E₂.

FIG. 5 illustrates a schematic diagram of the vibration isolation unit 100. The length and the initial angle of the segments of the support members 106 and 108 in the upper layer of the vibration isolation unit 100 are denoted by L₁ and θ₁. The length of the segments of the support members 114 and 116 in the low layer is L₂, and the corresponding initial angle is represented by θ₂. The lengths of the segments of the support members 106, 108, 114, and 116 in the left and right sides of the vibration isolation unit 100 are denoted by L₃ and L₄. The distance between points B₁ and B₄ is equal to the distance between points E₁ and E₂. The spring “1” with stiffness kₘ in the horizontal direction may be installed between points C₁ and C₂ and may provide the main stiffness of the unit. The springs “2” and “3” with stiffness kᵤ may be connected at points B₂ and B₃ in the upper layer and may help prevent the vibration isolation unit 100 from overturning. The lengths of A₂B₃ and A₃B₂ are equal to αL₁, in which a denotes the spring connection parameter and 0≤α≤1. The springs “4” and “5” with stiffness kₗ may be connected at the points D₂ and D₃ in the low layer and may help enhance the lateral stiffness of the vibration isolation unit 100. The lengths of E₁D₂ and E₂D₃ are equal to βL₂, in which β also denotes the spring connection parameter and 0≤β≤1. The material of the support members 106, 108, 114, and 116 can be any suitable lightweight but stiff material, and compared with the deformation of springs, the elastic deflections of the support members 106, 108, 114, and 116 are all small and can be ignored.

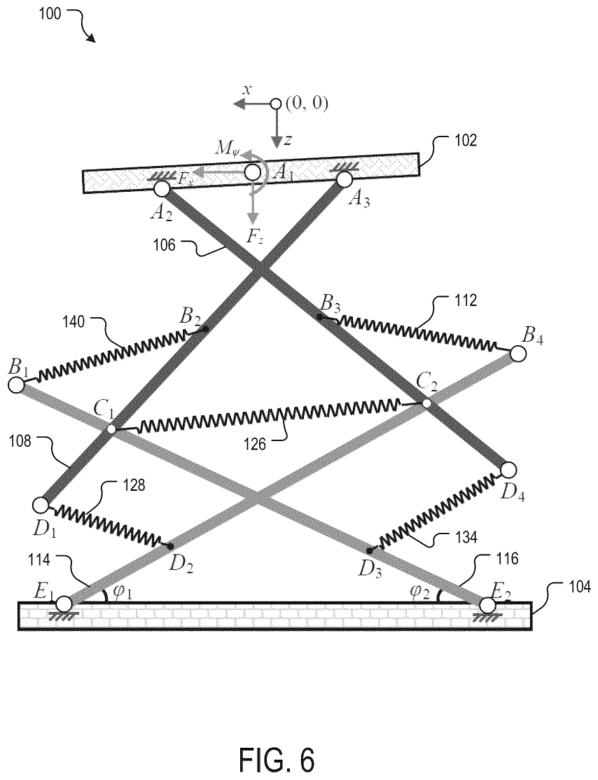

FIG. 6 illustrates a schematic diagram of the vibration isolation unit 100 showing movement of the vibration isolation unit 100 and deformation of the springs under the horizontal force Fₓ, vertical force F_{z} and bending moment M_{ψ}. It is noted that the origin of the coordinates is located at point A₁, and the motion of the vibration isolation unit 100 can be simplified as the horizontal and vertical translations and the in-plane rotation of point A₁. The coordinates of points A₁, A₂ and A₃ and the points B₁, B₂, B₃ and B₄ in the vibration isolation unit 100 before mechanism movement can be expressed by Equations 1a, 1b, and 1c.

$${A}_{1} = \{ 0 , 0 \} , {A}_{2} = \{ {L}_{1} cos {θ}_{1} - \frac{1}{2} ( {L}_{2} - {L}_{3} ) cos {θ}_{2} , 0 \} , \\ {A}_{3} = \{ - {L}_{1} cos {θ}_{1} + \frac{1}{2} ( {L}_{2} - {L}_{3} ) cos {θ}_{2} , 0 \} , \qquad ( 1 a )$$

$${B}_{1} = \{ \frac{1}{2} ( {L}_{2} + {L}_{3} ) cos {θ}_{2} , {L}_{1} sin {θ}_{1} - {L}_{3} sin {θ}_{2} \} , \\ {B}_{2} = \{ {L}_{1} cos {θ}_{1} ( α - 1 ) + \frac{1}{2} ( {L}_{2} - {L}_{3} ) cos {θ}_{2} , α {L}_{1} sin {θ}_{1} \} , \qquad ( 1 b )$$

$${B}_{3} = \{ {L}_{1} cos {θ}_{1} ( 1 - α ) - \frac{1}{2} ( {L}_{2} - {L}_{3} ) cos {θ}_{2} , α {L}_{1} sin {θ}_{1} \} , \\ {B}_{4} = \{ - \frac{1}{2} ( {L}_{2} + {L}_{3} ) cos {θ}_{2} , {L}_{1} sin {θ}_{1} - {L}_{3} sin {θ}_{2} \} . \qquad ( 1 c )$$

In addition, the corresponding coordinates of the points C₁, C₂, D₁, D₂, D₃, D₄, E₁ and E₂ in the vibration isolation unit 100 before mechanism movement can be expressed by Equations 2a, 2b, 2c, and 2d below.

$${C}_{1} = \{ \frac{1}{2} ( {L}_{2} - {L}_{3} ) cos {θ}_{2} , {L}_{1} sin {θ}_{1} \} , {C}_{2} = \{ \frac{1}{2} ( {L}_{3} - {L}_{2} ) cos {θ}_{2} , {L}_{1} sin {θ}_{1} \} , \qquad ( 2 a )$$

$${D}_{1} = \{ \frac{1}{2} ( {L}_{2} - {L}_{3} ) cos {θ}_{2} + {L}_{4} cos {θ}_{1} , ( {L}_{1} + {L}_{4} ) sin {θ}_{1} \} , \text{} {D}_{2} = \{ \frac{1}{2} ( {L}_{2} + {L}_{3} ) cos {θ}_{2} - β {L}_{2} cos {θ}_{2} , {L}_{1} sin {θ}_{1} + ( 1 - β ) {L}_{2} sin {θ}_{2} \} , \qquad ( 2 b )$$

$${D}_{3} = \{ β {L}_{2} cos {θ}_{2} - \frac{1}{2} ( {L}_{2} + {L}_{3} ) cos {θ}_{2} , {L}_{1} sin {θ}_{1} + ( 1 - β ) {L}_{2} sin {θ}_{2} \} , \text{} {D}_{4} = \frac{1}{2} ( {L}_{3} - {L}_{2} ) cos {θ}_{2} - {L}_{4} cos {θ}_{1} , ( {L}_{1} + {L}_{4} ) sin {θ}_{1} \} , \qquad ( 2 c )$$

$${E}_{1} = \{ \frac{1}{2} ( {L}_{2} + {L}_{3} ) cos {θ}_{2} , {L}_{1} sin {θ}_{1} + {L}_{2} sin {θ}_{2} \} , \text{} {E}_{2} = \{ - \frac{1}{2} ( {L}_{2} + {L}_{3} ) cos {θ}_{2} , {L}_{1} sin {θ}_{1} + {L}_{2} sin {θ}_{2} \} , \qquad ( 2 d )$$

It will be appreciated that point A₂ is located at the joint 110, point A₃ is located at the joint 112, point B₁ is located at the joint 142, point B₂ is located at the joint 144, point B₃ is located at the joint 150, point B₄ is located at the joint 148. Additionally, point C₁ is located at the joint 122, point C₂ is located at the joint 124, point D₁ is located at the joint 130, point D₂ is located at the joint 132, point D₃ is located at the joint 138, point D₄ is located at the joint 136, point E₁ is located at the joint 118, and point E₂ is located at the joint 120.

After the mechanism movement of the vibration isolation unit 100, the displacements of point A₁ in the horizontal and vertical directions can be denoted by x and z, and the in-plane rotation angle can be represented by ψ. Therefore, the coordinates of points A₁, A₂ and A₃ can be expressed by the below Equations 3a and 3b.

$${A}_{1} = \{ x , z \} , {A}_{2} = \{ x + {L}_{1} cos {θ}_{1} cos ψ - \frac{1}{2} ( {L}_{2} - {L}_{3} ) cos {θ}_{2} cos ψ , \\ z + {L}_{1} cos {θ}_{1} sin ψ - \frac{1}{2} ( {L}_{2} - {L}_{3} ) cos {θ}_{2} sin ψ \} , \qquad ( 3 a )$$

$${A}_{3} = \{ x - {L}_{1} cos {θ}_{1} cos ψ + \frac{1}{2} ( {L}_{2} - {L}_{3} ) cos {θ}_{2} cos ψ , \\ z - {L}_{1} cos {θ}_{1} sin ψ + \frac{1}{2} ( {L}_{2} - {L}_{3} ) cos {θ}_{2} sin ψ \} , \qquad ( 3 b )$$

The angles between the support members 114, 116 and the horizontal direction after the mechanism movement are represented by φ₁ and φ₂. Based on the mechanism movement relationship of the vibration isolation unit 100, the corresponding coordinates of points C₁ and C₂ in the vibration isolation unit 100 after mechanism movement can be expressed by the below Equations 4a and 4b.

$${C}_{1} = \{ {L}_{2} cos {φ}_{2} - \frac{1}{2} ( {L}_{2} + {L}_{3} ) cos {θ}_{2} , {L}_{1} sin {θ}_{1} + {L}_{2} sin {θ}_{2} - {L}_{2} sin {φ}_{2} \} , \qquad ( 4 a )$$

$${C}_{2} = \{ - {L}_{2} cos {φ}_{1} + \frac{1}{2} ( {L}_{2} + {L}_{3} ) cos {θ}_{2} , {L}_{1} sin {θ}_{1} + {L}_{2} sin {θ}_{2} - {L}_{2} sin {φ}_{1} \} . \qquad ( 4 b )$$

The length L₁ of the support member segments A₂C₂ and A₃C₁ can be expressed by the coordinates of the points A₂, A₃, C₁ and C₂ after mechanism movement as Equation 5 below and according to each of Equations 6a, 6b, 6c, and 6d below.

$${( {A}_{2 x} - {C}_{2 x} )}^{2} + {( {A}_{2 z} - {C}_{2 z} )}^{2} = {L}_{1}^{2} , \\ {( {A}_{3 x} - {C}_{1 x} )}^{2} + {( {A}_{3 z} - {C}_{1 z} )}^{2} = {L}_{1}^{2} , \qquad ( 5 )$$

$${A}_{2 x} = x + {L}_{1} cos {θ}_{1} cos ψ - \frac{1}{2} ( {L}_{2} - {L}_{3} ) cos {θ}_{2} cos ψ , \\ {A}_{2 z} = z + {L}_{1} cos {θ}_{1} sin ψ - \frac{1}{2} ( {L}_{2} - {L}_{3} ) cos {θ}_{2} sin ψ , \qquad ( 6 a )$$

$${A}_{3 x} = x - {L}_{1} cos {θ}_{1} cos ψ + \frac{1}{2} ( {L}_{2} - {L}_{3} ) cos {θ}_{2} cos ψ , \\ {A}_{3 z} = z - {L}_{1} cos {θ}_{1} sin ψ + \frac{1}{2} ( {L}_{2} - {L}_{3} ) cos {θ}_{2} sin ψ , \qquad ( 6 b )$$

$${C}_{1 x} = {L}_{2} cos {φ}_{2} - \frac{1}{2} ( {L}_{2} + {L}_{3} ) cos {θ}_{2} , \\ {C}_{1 z} = {L}_{1} sin {θ}_{1} + {L}_{2} sin {θ}_{2} - {L}_{2} sin {φ}_{2} , \qquad ( 6 c )$$

$${C}_{2 x} = - {L}_{2} cos {φ}_{1} + \frac{1}{2} ( {L}_{2} + {L}_{3} ) cos {θ}_{2} , \\ {C}_{2 z} = {L}_{1} sin {θ}_{1} + {L}_{2} sin {θ}_{2} - {L}_{2} sin {φ}_{1} . \qquad ( 6 d )$$

Substituting Equations 6a to 6d into Equation 5, the angles φ₁ and φ₂ between the support members 114, 116, and the horizontal direction after mechanism movement can be solved. Then, the coordinates of the points C₁ and C₂ in the vibration isolation unit 100 can be obtained. Therefore, the corresponding coordinates of the points B₁, B₂, B₃ and B₄ in the vibration isolation unit 100 after mechanism movement can be expressed by Equations 7a and 7b below and according to each of Equations 8a, 8b, 8c, and 8d below.

$${B}_{1} = \{ ( {L}_{2} + {L}_{3} ) cos {φ}_{2} - \frac{1}{2} ( {L}_{2} + {L}_{3} ) cos {θ}_{2} , \text{} {L}_{1} sin {θ}_{1} + {L}_{2} sin {θ}_{2} - ( {L}_{2} + {L}_{3} ) sin {φ}_{2} \} , {B}_{2} = \{ {B}_{2 x} , {B}_{2 z} \} , \qquad ( 7 a )$$

$${B}_{3} = \{ {B}_{3 x} , {B}_{3 z} \} , {B}_{4} = \{ - ( {L}_{2} + {L}_{3} ) cos {φ}_{1} + \frac{1}{2} ( {L}_{2} + {L}_{3} ) cos {θ}_{2} , \text{} {L}_{1} sin {θ}_{1} + {L}_{2} sin {θ}_{2} - ( {L}_{2} + {L}_{3} ) sin {φ}_{1} \} , \qquad ( 7 b )$$

$${B}_{2 x} = α [ {L}_{2} cos {φ}_{2} - \frac{1}{2} ( {L}_{2} + {L}_{3} ) cos {θ}_{2} ] + ( 1 - α ) [ x - {L}_{1} cos {θ}_{1} cos ψ + \frac{1}{2} ( {L}_{2} - {L}_{3} ) cos {θ}_{2} cos ψ ] , \qquad ( 8 a )$$

$${B}_{2 z} = α ( {L}_{1} sin {θ}_{1} + {L}_{2} sin {θ}_{2} - {L}_{2} sin {φ}_{2} ) + ( 1 - α ) [ z - {L}_{1} cos {θ}_{1} sin ψ + \frac{1}{2} ( {L}_{2} - {L}_{3} ) cos {θ}_{2} sin ψ ] , \qquad ( 8 b )$$

$${B}_{3 x} = α [ - {L}_{2} cos {φ}_{1} + \frac{1}{2} ( {L}_{2} + {L}_{3} ) cos {θ}_{2} ] + ( 1 - α ) [ x + {L}_{1} cos {θ}_{1} cos ψ - \frac{1}{2} ( {L}_{2} - {L}_{3} ) cos {θ}_{2} cos ψ ] , \qquad ( 8 c )$$

$${B}_{3 z} = α ( {L}_{1} sin {θ}_{1} + {L}_{2} sin {θ}_{2} - {L}_{2} sin {φ}_{1} ) + ( 1 - α ) [ z + {L}_{1} cos {θ}_{1} sin ψ - \frac{1}{2} ( {L}_{2} - {L}_{3} ) cos {θ}_{2} sin ψ ] . \qquad ( 8 d )$$

In addition, the corresponding coordinates of the points D₁, D₂, D₃ and D₄ in the vibration isolation unit 100 after mechanism movement can be expressed by the angles φ₁ and φ₂ and by Equations 9a and 9b and according to each of Equations 10a, 10b, 10c, and 10d below.

$${D}_{1} = \{ {D}_{1 x} , {D}_{1 z} \} , \text{} {D}_{2} = \{ \frac{1}{2} ( {L}_{2} + {L}_{3} ) cos {θ}_{2} - β {L}_{2} cos {φ}_{1} , {L}_{1} sin {θ}_{1} + {L}_{2} sin {θ}_{2} - β {L}_{2} sin {φ}_{1} \} , \qquad ( 9 a )$$

$${D}_{3} = \{ - \frac{1}{2} ( {L}_{2} + {L}_{3} ) cos {θ}_{2} + β {L}_{2} cos {φ}_{2} , \text{} {L}_{1} sin {θ}_{1} + {L}_{2} sin {θ}_{2} - β {L}_{2} sin {φ}_{2} \} , \text{} {D}_{4} = \{ {D}_{4 x} , {D}_{4 z} \} , \qquad ( 9 b )$$

$${D}_{1 x} = ( 1 + \frac{{L}_{4}}{{L}_{1}} ) [ {L}_{2} cos {φ}_{2} - \frac{1}{2} ( {L}_{2} + {L}_{3} ) cos {θ}_{2} ] - \frac{{L}_{4}}{{L}_{1}} [ x - {L}_{1} cos {θ}_{1} cos ψ + \frac{1}{2} ( {L}_{2} - {L}_{3} ) cos {θ}_{2} cos ψ ] , \qquad ( 10 a )$$

$${D}_{1 z} = ( 1 + \frac{{L}_{4}}{{L}_{1}} ) ( {L}_{1} sin {θ}_{1} + {L}_{2} sin {θ}_{2} - {L}_{2} sin {φ}_{2} ) - \frac{{L}_{4}}{{L}_{1}} [ z - {L}_{1} cos {θ}_{1} sin ψ + \frac{1}{2} ( {L}_{2} - {L}_{3} ) cos {θ}_{2} sin ψ ] , \qquad ( 10 b )$$

$${D}_{4 x} = ( 1 + \frac{{L}_{4}}{{L}_{1}} ) [ - {L}_{2} cos {φ}_{1} + \frac{1}{2} ( {L}_{2} + {L}_{3} ) cos {θ}_{2} ] - \frac{{L}_{4}}{{L}_{1}} [ x + {L}_{1} cos {θ}_{1} cos ψ - \frac{1}{2} ( {L}_{2} - {L}_{3} ) cos {θ}_{2} cos ψ ] , \qquad ( 10 c )$$

$${D}_{4 z} = ( 1 + \frac{{L}_{4}}{{L}_{1}} ) ( {L}_{1} sin {θ}_{1} + {L}_{2} sin {θ}_{2} - {L}_{2} sin {φ}_{1} ) - \frac{{L}_{4}}{{L}_{1}} [ z + {L}_{1} cos {θ}_{1} sin ψ - \frac{1}{2} ( {L}_{2} - {L}_{3} ) cos {θ}_{2} sin ψ ] . \qquad ( 10 d )$$

According to the mechanism movement analysis, the deformations of the different springs in the vibration isolation unit 100 can be obtained. The original length l₁₀ of the spring “1” can be expressed as Equation 11 below. Based on the geometrical relationship, the length l₁₁ of the spring “1” after deformation in the vibration isolation unit 100 can be expressed by Equation 12 below. Accordingly, the deformation length Δl₁ of the spring “1” can be written as Equation 13 below.

$${l}_{10} = ( {L}_{2} - {L}_{3} ) cos {θ}_{2} . \qquad ( 11 )$$

$${l}_{11} = \sqrt{\begin{matrix}( {L}_{2} cos {φ}_{2} + {L}_{2} cos {φ}_{1} - {L}_{2} cos {θ}_{2} - \\ {{L}_{3} cos {θ}_{2} )}^{2} + {( {L}_{2} sin {φ}_{1} - {L}_{2} sin {φ}_{2} )}^{2}\end{matrix}} . \qquad ( 12 )$$

$$Δ {l}_{1} = \sqrt{\begin{matrix}( {L}_{2} cos {φ}_{2} + {L}_{2} cos {φ}_{1} - {L}_{2} cos {θ}_{2} - \\ {{L}_{3} cos {θ}_{2} )}^{2} + {( {L}_{2} sin {φ}_{1} - {L}_{2} sin {φ}_{2} )}^{2}\end{matrix}} - ( {L}_{2} - {L}_{3} ) cos {θ}_{2} . \qquad ( 13 )$$

The original lengths l₂₀ and l₃₀ of the springs “2” and “3” can be expressed as Equation 14 below. After they are deformed, the lengths l₂₁ and l₃₁ of the springs “2” and “3” can be written as Equations 15a and 15b below. Thus, the deformation lengths Δl₂ and Δl₃ of the linear springs “2” and “3” after mechanism movement can be expressed by Equations 16a and 16b below.

$${l}_{20} = {l}_{30} = \sqrt{\begin{matrix}{[ ( 1 - α ) {L}_{1} cos {θ}_{1} + {L}_{3} cos {θ}_{2} ]}^{2} + \\ {[ ( 1 - α ) {L}_{1} sin {θ}_{1} - {L}_{3} sin {θ}_{2} ]}^{2}\end{matrix}} . \qquad ( 14 )$$

$${l}_{21} = \sqrt{\begin{matrix}{[ {B}_{2 x} - ( {L}_{2} + {L}_{3} ) cos {φ}_{2} + \frac{1}{2} ( {L}_{2} + {L}_{3} ) cos {θ}_{2} ]}^{2} + \\ {[ {B}_{2 z} - {L}_{1} sin {θ}_{1} - {L}_{2} sin {θ}_{2} + ( {L}_{2} + {L}_{3} ) sin {φ}_{2} ]}^{2}\end{matrix}} , \qquad ( 15 a )$$

$${l}_{31} = \sqrt{\begin{matrix}{[ {B}_{3 x} + ( {L}_{2} + {L}_{3} ) cos {φ}_{1} - \frac{1}{2} ( {L}_{2} + {L}_{3} ) cos {θ}_{2} ]}^{2} + \\ {[ {B}_{3 z} - {L}_{1} sin {θ}_{1} - {L}_{2} sin {θ}_{2} + ( {L}_{2} + {L}_{3} ) sin {φ}_{1} ]}^{2}\end{matrix}} . \qquad ( 15 b )$$

$$Δ {l}_{2} = \sqrt{\begin{matrix}{[ {B}_{2 x} - ( {L}_{2} + {L}_{3} ) cos {φ}_{2} + \frac{1}{2} ( {L}_{2} + {L}_{3} ) cos {θ}_{2} ]}^{2} + \\ {[ {B}_{2 z} - {L}_{1} sin {θ}_{1} - {L}_{2} sin {θ}_{2} + ( {L}_{2} + {L}_{3} ) sin {φ}_{2} ]}^{2}\end{matrix}} - {l}_{20} , \qquad ( 16 a )$$

$$Δ {l}_{3} = \sqrt{\begin{matrix}{[ {B}_{3 x} + ( {L}_{2} + {L}_{3} ) cos {φ}_{1} - \frac{1}{2} ( {L}_{2} + {L}_{3} ) cos {θ}_{2} ]}^{2} + \\ {[ {B}_{3 z} - {L}_{1} sin {θ}_{1} - {L}_{2} sin {θ}_{2} + ( {L}_{2} + {L}_{3} ) sin {φ}_{1} ]}^{2}\end{matrix}} - {l}_{30} . \qquad ( 16 b )$$

Additionally, the original length l₄₀ and the length l₄₁ of the spring “4” after deformation in the vibration isolation unit 100 can be expressed as Equations 17a and 17b below. Hence, the deformation length Δl₄ of the spring “4” after mechanism movement can be written as Equation 18.

$${l}_{40} = \sqrt{\begin{matrix}{( {L}_{4} cos {θ}_{1} - {L}_{3} cos {θ}_{2} + β {L}_{2} cos {θ}_{2} )}^{2} + \\ {[ {L}_{4} sin {θ}_{1} - ( 1 - β ) {L}_{2} sin {θ}_{2} ]}^{2}\end{matrix}} , \qquad ( 17 a )$$

$${l}_{41} = \sqrt{\begin{matrix}{[ {D}_{1 x} - \frac{1}{2} ( {L}_{2} + {L}_{3} ) cos {θ}_{2} + β {L}_{2} cos {φ}_{1} ]}^{2} + \\ {( {D}_{1 z} - {L}_{1} sin {θ}_{1} - {L}_{2} sin {θ}_{2} + β {L}_{2} sin {φ}_{1} )}^{2}\end{matrix}} . \qquad ( 17 b )$$

$$Δ {l}_{4} = \sqrt{\begin{matrix}{[ {D}_{1 x} - \frac{1}{2} ( {L}_{2} + {L}_{3} ) cos {θ}_{2} + β {L}_{2} cos {φ}_{1} ]}^{2} + \\ {( {D}_{1 z} - {L}_{1} sin {θ}_{1} - {L}_{2} sin {θ}_{2} + β {L}_{2} sin {φ}_{1} )}^{2}\end{matrix}} - {l}_{40} . \qquad ( 18 )$$

Similarly, the original length l₅₀ and the length l₅₁ of the spring “5” after deformation in the vibration isolation unit 100 can be expressed by Equations 19a and 19b. Accordingly, the deformation length Δl₅ of the linear spring “5” after mechanism movement can be obtained as Equation 20.

$${l}_{50} = \sqrt{\begin{matrix}{( {L}_{4} cos {θ}_{1} - {L}_{3} cos {θ}_{2} + β {L}_{2} cos {θ}_{2} )}^{2} + \\ {[ {L}_{4} sin {θ}_{1} - ( 1 - β ) {L}_{2} sin {θ}_{2} ]}^{2}\end{matrix}} , \qquad ( 19 a )$$

$${l}_{51} = \sqrt{\begin{matrix}{[ {D}_{4 x} + \frac{1}{2} ( {L}_{2} + {L}_{3} ) cos {θ}_{2} - β {L}_{2} cos {φ}_{2} ]}^{2} + \\ {( {D}_{4 z} - {L}_{1} sin {θ}_{1} - {L}_{2} sin {θ}_{2} + β {L}_{2} sin {φ}_{2} )}^{2}\end{matrix}} . \qquad ( 19 b )$$

$$Δ {l}_{5} = \sqrt{\begin{matrix}{[ {D}_{4 x} + \frac{1}{2} ( {L}_{2} + {L}_{3} ) cos {θ}_{2} - β {L}_{2} cos {φ}_{2} ]}^{2} + \\ {( {D}_{4 z} - {L}_{1} sin {θ}_{1} - {L}_{2} sin {θ}_{2} + β {L}_{2} sin {φ}_{2} )}^{2}\end{matrix}} - {l}_{50} . \qquad ( 20 )$$

It should be noted that, the deformation lengths of the linear springs “1-5” in the unit are denoted by Δl₁, Δl₂, Δl₃, Δl₄ and Δl₅, and the detailed expressions of the deformation lengths Δl₁, Δl₂, Δl₃, Δl₄ and Δl₅ can be found in Equations 13, 16, 18 and 20. It can be found that the deformation lengths Δl₁, Δl₂, Δl₃, Δl₄ and Δl₅ are the functions of the angles φ₁ and φ₂.

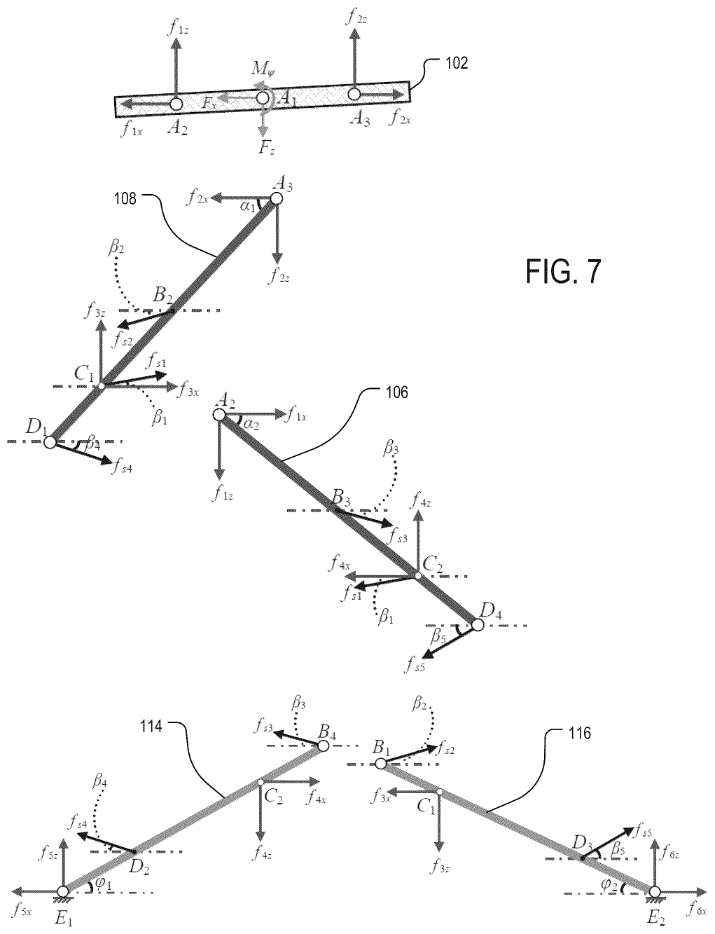

FIG. 7 illustrates the static analysis of the base member 102 and support members 106, 108, 114, and 116 in the unit with the horizontal, vertical and rotational loads Fₓ, F_{z} and M_{ψ}. According to the static analysis of the base member 102, the force and moment equilibrium equations can be expressed as Equations 21a, 21b, and 21c in which f₁ₓ and f_{1z} represent the supporting forces produced by rod A₂D₄, and f₂ₓ and f_{2z} denote the supporting forces produced by rod A₃D₁.

$${F}_{x} + {f}_{1 x} - {f}_{2 x} = 0 , \qquad ( 21 a )$$

$${F}_{z} - {f}_{1 z} - {f}_{2 z} = 0 , \qquad ( 21 b )$$

$${M}_{ψ} + \frac{1}{2} ( 2 {L}_{1} cos {θ}_{1} + {L}_{3} cos {θ}_{2} - {L}_{2} cos {θ}_{2} ) cos ψ ( {f}_{2 z} - {f}_{1 z} ) - \frac{1}{2} ( 2 {L}_{1} cos {θ}_{1} + {L}_{3} cos {θ}_{2} - {L}_{2} cos {θ}_{2} ) sin ψ ( {f}_{1 x} + {f}_{2 x} ) = 0 , \qquad ( 21 c )$$

For the supporting rods A₂D₄ and A₃D₁, the force and moment equilibrium equations can be written as Equations 22a to 22f below where f₃ₓ and f_{3z} denote the forces on the joint C₁, f₄ₓ and f_{4z} are the forces on the joint C₂, fₛ₁, fₛ₂, fₛ₃, fₛ₄ and fₛ₅ represent the forces of the springs “1”, “2”, “3”, “4” and “5”, α₁ and α₂ are the inclination angles of the rods A₃D₁ and A₂D₄, and β₁, β₂, β₃, β₄ and β₅ are the angles between forces fₛ₁, fₛ₂, fₛ₃, fₛ₄ and fₛ₅ and the horizontal direction.

f_{3z}−f_{2z}−fₛ₂ sin β₂+fₛ₁ sin β₁−fₛ₄ sin β₄=0, (22a)

f₂ₓ−f₃ₓ+fₛ₂ cos β₂−fₛ₁ cos β₁−fₛ₄ cos β₄=0, (22b)

fₛ₂ sin β₂αL₁ cos α₁−fₛ₂ cos β₂αL₁ sin α₁+(f₃ₓ+fₛ₁ cos β₁)L₁ sin α₁−(f_{3z}+fₛ₁ sin β₁)L₁ cos α₁+fₛ₄ cos β₄(L₁+L₄)sin α₁+fₛ₄ sin β₄(L₁+L₄)cos α₁=0, (22c)

f_{4z}−f_{1z}−fₛ₃ sin β₃−fₛ₁ sin β₁−fₛ₅ sin β₅=0, (22d)

f₄ₓ−f₁ₓ−fₛ₃ cos β₃+fₛ₁ cos β₁+fₛ₅ cos β₅=0, (22e)

fₛ₃ sin β₃αL₁ cos α₂−fₛ₃ cos β₃αL₁ sin α₂+(f₄ₓ+fₛ₁ cos β₁)L₁ sin α₂+(fₛ₁ sin β₁−f_{4z})L₁ cos α₂+fₛ₅ cos β₅(L₁+L₄)sin α₂+fₛ₅ sin β₅(L₁+L₄)cos α₂=0, (22f)

The inclination angles α₁ and α₂ can be obtained by Equations 23a to 23d below. The inclination angles β₁, β₂, β₃, β₄ and β₅ can be obtained by Equations 24a to 24e below.

$$sin {α}_{1} = \frac{\begin{matrix}{L}_{1} sin {θ}_{1} + {L}_{2} sin {θ}_{2} - {L}_{2} sin {φ}_{2} - z + \\ {L}_{1} cos {θ}_{1} sin ψ - \frac{1}{2} ( {L}_{2} - {L}_{3} ) cos {θ}_{2} sin ψ\end{matrix}}{{L}_{1}} , \qquad ( 23 a )$$

$$cos {α}_{1} = \frac{\begin{matrix}{L}_{2} cos {φ}_{2} - \frac{1}{2} ( {L}_{2} + {L}_{3} ) cos {θ}_{2} - x + \\ {L}_{1} cos {θ}_{1} cos ψ - \frac{1}{2} ( {L}_{2} - {L}_{3} ) cos {θ}_{2} cos ψ\end{matrix}}{{L}_{1}} , \qquad ( 23 b )$$

$$sin {α}_{2} = \frac{\begin{matrix}{L}_{1} sin {θ}_{1} + {L}_{2} sin {θ}_{2} - {L}_{2} sin {φ}_{1} - z - \\ {L}_{1} cos {θ}_{1} sin ψ + \frac{1}{2} ( {L}_{2} - {L}_{3} ) cos {θ}_{2} sin ψ\end{matrix}}{{L}_{1}} , \qquad ( 23 c )$$

$$cos {α}_{2} = \frac{\begin{matrix}x + {L}_{1} cos {θ}_{1} cos ψ - \frac{1}{2} ( {L}_{2} - {L}_{3} ) cos {θ}_{2} cos ψ + \\ {L}_{2} cos {φ}_{1} - \frac{1}{2} ( {L}_{2} + {L}_{3} ) cos {θ}_{2}\end{matrix}}{{L}_{1}} . \qquad ( 23 d )$$

$$sin {β}_{1} = \frac{{L}_{2} sin {φ}_{1} - {L}_{2} sin {φ}_{2}}{{l}_{11}} , \\ cos {β}_{1} = \frac{{L}_{2} cos {φ}_{2} + {L}_{2} cos {φ}_{1} - ( {L}_{2} + {L}_{3} ) cos {θ}_{2}}{{l}_{11}} , \qquad ( 24 a )$$

$$sin {β}_{2} = \frac{{L}_{1} sin {θ}_{1} + {L}_{2} sin {θ}_{2} - ( {L}_{2} + {L}_{3} ) sin {φ}_{2} - {B}_{2 z}}{{l}_{21}} , \\ cos {β}_{2} = \frac{( {L}_{2} + {L}_{3} ) cos {φ}_{2} - \frac{1}{2} ( {L}_{2} + {L}_{3} ) cos {θ}_{2} - {B}_{2 x}}{{l}_{21}} , \qquad ( 24 b )$$

$$sin {β}_{3} = \frac{{L}_{1} sin {θ}_{1} + {L}_{2} sin {θ}_{2} - ( {L}_{2} + {L}_{3} ) sin {φ}_{1} - {B}_{3 z}}{{l}_{31}} , \\ cos {β}_{3} = \frac{{B}_{3 x} + ( {L}_{2} + {L}_{3} ) cos {φ}_{1} - \frac{1}{2} ( {L}_{2} + {L}_{3} ) cos {θ}_{2}}{{l}_{31}} , \qquad ( 24 c )$$

$$sin {β}_{4} = \frac{{L}_{1} sin {θ}_{1} + {L}_{2} sin {θ}_{2} - β {L}_{2} sin {φ}_{1} - {D}_{1 z}}{{l}_{41}} , \\ cos {β}_{4} = \frac{{D}_{1 x} - \frac{1}{2} ( {L}_{2} + {L}_{3} ) cos {θ}_{2} + β {L}_{2} cos {φ}_{1}}{{l}_{41}} , \qquad ( 24 d )$$

$$sin {β}_{5} = \frac{{L}_{1} sin {θ}_{1} + {L}_{2} sin {θ}_{2} - β {L}_{2} sin {φ}_{2} - {D}_{4 z}}{{l}_{51}} , \\ cos {β}_{5} = \frac{- \frac{1}{2} ( {L}_{2} + {L}_{3} ) cos {θ}_{2} + β {L}_{2} cos {φ}_{2} - {D}_{4 x}}{{l}_{51}} . \qquad ( 24 e )$$

For the static analysis of the supporting rods B₁E₂ and B₄E₁, the moment equilibrium equations of the joints E₁ and E₂ can be expressed by Equations 25a and 25b.

fₛ₃ sin β₃(L₂+L₃)cos φ₁+fₛ₃ cos β₃(L₂+L₃)sin φ₁−f₄ₓL₂ sin φ₁−f_{4z}L₂ cos φ₁+fₛ₄ sin β₄βL₂ cos φ₁+fₛ₄ cos β₄βL₂ sin φ₁=0, (25a)

fₛ₂ sin β₂(L₂+L₃)cos φ₂+fₛ₂ cos β₂(L₂+L₃)sin φ₂−f₃ₓL₂ sin φ₂−f_{3z}L₂ cos φ₂+fₛ₅ sin β₅βL₂ cos φ₂+fₛ₅ cos β₅βL₂ sin φ₂=0. (25b)

By solving Equations 22c, 22f, 25a and 25b, the forces f₃ₓ, f_{3z}, f₄ₓ and f_{4z} on the joints C₁ and C₂ can be obtained. Accordingly, the supporting forces f₁ₓ, f_{1z}, f₂ₓ and f_{2z} produced by rods A₂D₄ and A₃D₁ can be expressed as Equations 26a to 26d below.

f₁ₓ=f₄ₓ−fₛ₃ cos β₃+fₛ₁ cos β₁+fₛ₅ cos β₅, (26a)

f_{1z}=f_{4z}−fₛ₃ sin β₃−fₛ₁ sin β₁−fₛ₅ sin β₅, (26b)

f₂ₓ=f₃ₓ−fₛ₂ cos β₂+fₛ₁ cos β₁+fₛ₄ cos β₄, (26c)

f_{2z}=f_{3z}−fₛ₂ sin β₂+sin β₁−fₛ₄ sin β₄. (26d)

The deformations of all springs in the vibration isolation unit 100 under the horizontal force Fₓ, vertical force F_{z} and bending moment M_{ψ} have been analyzed and obtained above. Therefore, the tensions fₛ₁, fₛ₂, fₛ₃, fₛ₄ and fₛ₅ of the linear springs “1”, “2”, “3”, “4” and “5” in the vibration isolation unit can be expressed by Equations 27a to 27e.

$${f}_{s 1} = {k}_{m} \sqrt{\begin{matrix}( {L}_{2} cos {φ}_{2} + {L}_{2} cos {φ}_{1} - {L}_{2} cos {θ}_{2} - \\ {{L}_{3} cos {θ}_{2} )}^{2} + {( {L}_{2} sin {φ}_{1} - {L}_{2} sin {φ}_{2} )}^{2}\end{matrix}} - {k}_{m} ( {L}_{2} - {L}_{3} ) cos {θ}_{2} , \qquad ( 27 a )$$

$${f}_{s 2} = {k}_{u} \sqrt{\begin{matrix}{[ {B}_{2 x} - ( {L}_{2} + {L}_{3} ) cos {φ}_{2} + \frac{1}{2} ( {L}_{2} + {L}_{3} ) cos {θ}_{2} ]}^{2} + \\ {[ {B}_{2 z} - {L}_{1} sin {θ}_{1} - {L}_{2} sin {θ}_{2} + ( {L}_{2} + {L}_{3} ) sin {φ}_{2} ]}^{2}\end{matrix}} - {k}_{u} {l}_{20} , \qquad ( 27 b )$$

$${f}_{s 3} = {k}_{u} \sqrt{\begin{matrix}{[ {B}_{3 x} + ( {L}_{2} + {L}_{3} ) cos {φ}_{1} - \frac{1}{2} ( {L}_{2} + {L}_{3} ) cos {θ}_{2} ]}^{2} + \\ {[ {B}_{3 z} - {L}_{1} sin {θ}_{1} - {L}_{2} sin {θ}_{2} + ( {L}_{2} + {L}_{3} ) sin {φ}_{1} ]}^{2}\end{matrix}} - {k}_{u} {l}_{30} , \qquad ( 27 c )$$

$${f}_{s 4} = {k}_{l} \sqrt{\begin{matrix}{[ {D}_{1 x} - \frac{1}{2} ( {L}_{2} + {L}_{3} ) cos {θ}_{2} + β {L}_{2} cos {φ}_{1} ]}^{2} + \\ {( {D}_{1 z} - {L}_{1} sin {θ}_{1} - {L}_{2} sin {θ}_{2} + β {L}_{2} sin {φ}_{1} ]}^{2}\end{matrix}} - {k}_{l} {l}_{40} , \qquad ( 27 d )$$

$${f}_{s 5} = {k}_{l} \sqrt{\begin{matrix}{[ {D}_{4 x} + \frac{1}{2} ( {L}_{2} + {L}_{3} ) cos {θ}_{2} - β {L}_{2} cos {φ}_{2} ]}^{2} + \\ {( {D}_{4 z} - {L}_{1} sin {θ}_{1} - {L}_{2} sin {θ}_{2} + β {L}_{2} sin {φ}_{2} ]}^{2}\end{matrix}} - {k}_{l} {l}_{50} . \qquad ( 27 e )$$

Based on the force and moment equilibrium Equations 21a to 21c, the horizontal force Fₓ, vertical force F_{z} and bending moment M_{ψ} of the vibration isolation unit 100 can be written as Equations 28a to 28c.

$${F}_{x} = {f}_{2 x} - {f}_{1 x} , \qquad ( 28 a )$$

$${F}_{z} = {f}_{1 z} + {f}_{2 z} , \qquad ( 28 b )$$

$${M}_{ψ} = - \frac{1}{2} ( 2 {L}_{1} cos {θ}_{1} + {L}_{3} cos {θ}_{2} - {L}_{2} cos {θ}_{2} ) cos ψ ( {f}_{2 z} - {f}_{1 z} ) + \frac{1}{2} ( 2 {L}_{1} cos {θ}_{1} + {L}_{3} cos {θ}_{2} - {L}_{2} cos {θ}_{2} ) sin ψ ( {f}_{1 x} + {f}_{2 x} ) . \qquad ( 28 c )$$

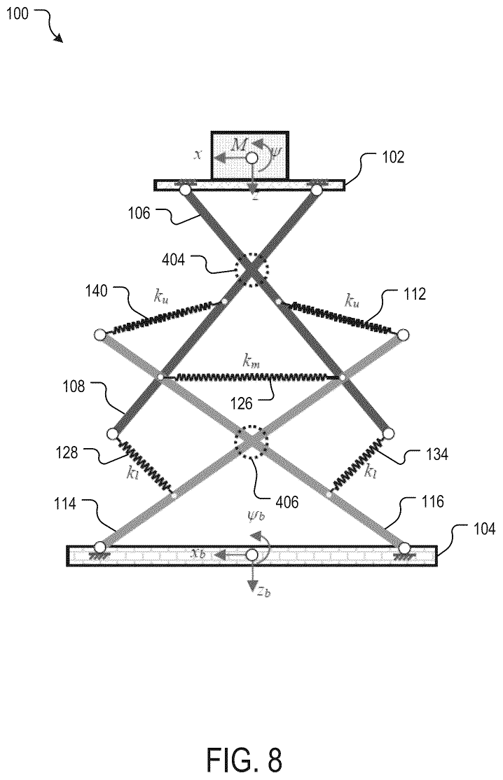

The absolute motions of the vibration isolation system in the horizontal, vertical and rotational directions are denoted by x, z and ψ, which can be seen from FIG. 8. Therefore, the kinetic energy T of the isolation object can be written as Equation 29 in which M and J are the mass and rotational inertia of the isolation object.

$$T = \frac{1}{2} M {\dot{x}}^{2} + \frac{1}{2} M {\dot{z}}^{2} + \frac{1}{2} J {\dot{ψ}}^{2} , \qquad ( 29 )$$

The relative motions xₐ, zₐ and ψₐ of the isolation object along the horizontal, vertical and rotational directions can be expressed by Equation 30 where x_{b}, z_{b} and ψ_{b} are the horizontal, vertical and rotational excitations from the base member 104, which can be observed from FIG. 8. The deformation lengths of the linear springs “1-5” in the vibration isolation unit 100 are denoted by Δl₁, Δl₂, Δl₃, Δl₄ and Δl₅. Therefore, the potential energy U of the vibration isolation unit 100 can be expressed by Equation 31.

$${x}_{a} = x - {x}_{b} , {z}_{a} = z - {z}_{b} , {ψ}_{a} = ψ - {ψ}_{b} , \qquad ( 30 )$$

$$U = \frac{1}{2} {k}_{m} Δ {l}_{1}^{2} + \frac{1}{2} {k}_{u} Δ {l}_{2}^{2} + \frac{1}{2} {k}_{u} Δ {l}_{3}^{2} + \frac{1}{2} {k}_{l} Δ {l}_{4}^{2} + \frac{1}{2} {k}_{l} Δ {l}_{5}^{2} . \qquad ( 31 )$$

This description considers only viscous friction for convenience in discussion, and there are six joints including A₂, A₃, C₁, C₂, E₁ and E₂ in the vibration isolation unit 100. The rotational angles Φ₁, Φ₂, Φ₃, Φ₄, Φ₅ and Φ₆ of joints A₂, A₃, C₁, C₂, E₁ and E₂ are equal to α₂−θ₁, α₁−θ₁, α₁+φ₂−θ₁−θ₂, α₂+φ₁−θ₁−θ₂, φ₁−θ₂ and φ₂−θ₁, respectively. With the consideration of the damping effect, the generalized forces Rₓ, R_{y} and R_{ψ} of the vibration isolation unit 100 in the horizontal, vertical and rotational directions with the non-constraint forces Fᵢ along with the virtual displacements ∂rᵢ can be expressed as Equations 32a to 32c in which c₁ₓ, c_{1z} and c_{1ψ} denote the air damping coefficients of each DOF, and c₂ₓ, c_{2z} and c_{2ψ} represent the rotational friction damping coefficients of the joints.

$${R}_{x} = \sum {F}_{i} \frac{\partial {r}_{i}}{\partial x} = - {c}_{1 x} {\dot{x}}_{a} \frac{\partial {x}_{a}}{\partial x} - {c}_{2 x} {\sum }_{j = 1}^{6} {\dot{Φ}}_{j} \frac{\partial {Φ}_{j}}{\partial x} = - {c}_{1 x} {\dot{x}}_{a} - 2 {c}_{2 x} ( {\dot{φ}}_{1} \frac{\partial {φ}_{1}}{\partial x} + {\dot{φ}}_{2} \frac{\partial {φ}_{2}}{\partial x} + {\dot{α}}_{1} \frac{\partial {α}_{1}}{\partial x} + {\dot{α}}_{2} \frac{\partial {α}_{2}}{\partial x} ) , \qquad ( 32 a )$$

$${R}_{z} = \sum {F}_{i} \frac{\partial {r}_{i}}{\partial z} = - {c}_{1 z} {\dot{z}}_{a} \frac{\partial {z}_{a}}{\partial z} - {c}_{2 z} {\sum }_{j = 1}^{6} {\dot{Φ}}_{j} \frac{\partial {Φ}_{j}}{\partial z} = - {c}_{1 z} {\dot{z}}_{a} - 2 {c}_{2 z} ( {\dot{φ}}_{1} \frac{\partial {φ}_{1}}{\partial z} + {\dot{φ}}_{2} \frac{\partial {φ}_{2}}{\partial z} + {\dot{α}}_{1} \frac{\partial {α}_{1}}{\partial z} + {\dot{α}}_{2} \frac{\partial {α}_{2}}{\partial z} ) , \qquad ( 32 b )$$

$${R}_{ψ} = \sum {F}_{i} \frac{\partial {r}_{i}}{\partial ψ} = - {c}_{1 ψ} {\dot{ψ}}_{a} \frac{\partial {ψ}_{a}}{\partial ψ} - {c}_{2 ψ} {\sum }_{j = 1}^{6} {\dot{Φ}}_{j} \frac{\partial {Φ}_{j}}{\partial ψ} = - {c}_{1 ψ} {\dot{ψ}}_{a} - 2 {c}_{2 ψ} ( {\dot{φ}}_{1} \frac{\partial {φ}_{1}}{\partial ψ} + {\dot{φ}}_{2} \frac{\partial {φ}_{2}}{\partial ψ} + {\dot{α}}_{1} \frac{\partial {α}_{1}}{\partial ψ} + {\dot{α}}_{2} \frac{\partial {α}_{2}}{\partial ψ} ) , \qquad ( 32 c )$$

To establish the nonlinear equations of motion of the vibration isolation unit 100, the Lagrange principle of the three-direction vibration is used, which can be expressed as Equations 33a to 33c.

$$\frac{d}{dt} ( \frac{\partial T}{\partial \dot{x}} - \frac{\partial U}{\partial \dot{x}} ) - ( \frac{\partial T}{\partial x} - \frac{\partial U}{\partial x} ) = {R}_{x} , \qquad ( 33 a )$$

$$\frac{d}{dt} ( \frac{\partial T}{\partial \dot{z}} - \frac{\partial U}{\partial \dot{z}} ) - ( \frac{\partial T}{\partial z} - \frac{\partial U}{\partial z} ) = {R}_{z} , \qquad ( 33 b )$$

$$\frac{d}{dt} ( \frac{\partial T}{\partial \dot{ψ}} - \frac{\partial U}{\partial \dot{ψ}} ) - ( \frac{\partial T}{\partial ψ} - \frac{\partial U}{\partial ψ} ) = {R}_{ψ} , \qquad ( 33 c )$$

Substituting Equations (29, 31 and 32a to 32c into Equations 33a to 33c, the nonlinear equations of motion of the vibration isolation unit 100 are obtained as Equations 34a to 34c in which the nonlinear functions fₙₓ, f_{nz}, f_{nψ}, f_{cx}, f_{cz} and f_{cψ} can be expressed as Equations 35a to 35f.

$$M {\ddot{x}}_{a} + {c}_{1 x} {\dot{x}}_{a} + 2 {c}_{2 x} {f}_{cx} {\dot{x}}_{a} + {f}_{nx} = - M {\ddot{x}}_{b} , \qquad ( 34 a )$$

$$M {\ddot{z}}_{a} + {c}_{1 z} {\dot{z}}_{a} + 2 {c}_{2 z} {f}_{cz} {\dot{z}}_{a} + {f}_{nz} = - M {\ddot{z}}_{b} , \qquad ( 34 b )$$

$$J {\ddot{ψ}}_{a} + {c}_{1 ψ} {\dot{ψ}}_{a} + 2 {c}_{2 ψ} {f}_{c ψ} {\dot{ψ}}_{a} + {f}_{n ψ} = - J {\ddot{ψ}}_{b} , \qquad ( 34 c )$$

$${f}_{nx} = {k}_{m} Δ {l}_{1} \frac{\partial Δ {l}_{1}}{\partial {x}_{a}} \frac{\partial {x}_{a}}{\partial x} + {k}_{u} Δ {l}_{2} \frac{\partial Δ {l}_{2}}{\partial {x}_{a}} \frac{\partial {x}_{a}}{\partial x} + {k}_{u} Δ {l}_{3} \frac{\partial Δ {l}_{3}}{\partial {x}_{a}} \frac{\partial {x}_{a}}{\partial x} + {k}_{l} Δ {l}_{4} \frac{\partial Δ {l}_{4}}{\partial {x}_{a}} \frac{\partial {x}_{a}}{\partial x} + {k}_{l} Δ {l}_{5} \frac{\partial Δ {l}_{5}}{\partial {x}_{a}} \frac{\partial {x}_{a}}{\partial x} , \qquad ( 35 a )$$

$${f}_{nz} = {k}_{m} Δ {l}_{1} \frac{\partial Δ {l}_{1}}{\partial {z}_{a}} \frac{\partial {z}_{a}}{\partial z} + {k}_{u} Δ {l}_{2} \frac{\partial Δ {l}_{2}}{\partial {z}_{a}} \frac{\partial {z}_{a}}{\partial z} + {k}_{u} Δ {l}_{3} \frac{\partial Δ {l}_{3}}{\partial {z}_{a}} \frac{\partial {z}_{a}}{\partial z} + {k}_{l} Δ {l}_{4} \frac{\partial Δ {l}_{4}}{\partial {z}_{a}} \frac{\partial {z}_{a}}{\partial z} + {k}_{l} Δ {l}_{5} \frac{\partial Δ {l}_{5}}{\partial {z}_{a}} \frac{\partial {z}_{a}}{\partial z} , \qquad ( 35 b )$$

$${f}_{n ψ} = {k}_{m} Δ {l}_{1} \frac{\partial Δ {l}_{1}}{\partial {ψ}_{a}} \frac{\partial {ψ}_{a}}{\partial ψ} + {k}_{u} Δ {l}_{2} \frac{\partial Δ {l}_{2}}{\partial {ψ}_{a}} \frac{\partial {ψ}_{a}}{\partial ψ} + {k}_{u} Δ {l}_{3} \frac{\partial Δ {l}_{3}}{\partial {ψ}_{a}} \frac{\partial {ψ}_{a}}{\partial ψ} + {k}_{l} Δ {l}_{4} \frac{\partial Δ {l}_{4}}{\partial {ψ}_{a}} \frac{\partial {ψ}_{a}}{\partial ψ} + {k}_{l} Δ {l}_{5} \frac{\partial Δ {l}_{5}}{\partial {ψ}_{a}} \frac{\partial {ψ}_{a}}{\partial ψ} , \qquad ( 35 c )$$

$${f}_{cx} = {( \frac{d {φ}_{1}}{{dx}_{a}} )}^{2} + {( \frac{d {φ}_{2}}{{dx}_{a}} )}^{2} + {( \frac{d {α}_{1}}{{dx}_{a}} )}^{2} + {( \frac{d {α}_{2}}{{dx}_{a}} )}^{2} , \qquad ( 35 d )$$

$${f}_{cz} = {( \frac{d {φ}_{1}}{{dz}_{a}} )}^{2} + {( \frac{d {φ}_{2}}{{dz}_{a}} )}^{2} + {( \frac{d {α}_{1}}{{dz}_{a}} )}^{2} + {( \frac{d {α}_{2}}{{dz}_{a}} )}^{2} , \qquad ( 35 e )$$

$${f}_{c ψ} = {( \frac{d {φ}_{1}}{d {ψ}_{a}} )}^{2} + {( \frac{d {φ}_{2}}{d {ψ}_{a}} )}^{2} + {( \frac{d {α}_{1}}{d {ψ}_{a}} )}^{2} + {( \frac{d {α}_{2}}{d {ψ}_{a}} )}^{2} . \qquad ( 35 f )$$

To analyze the equivalent nonlinear stiffness and damping characteristics in the vibration isolation unit 100, it is assumed that the variables in the other two degrees-of-freedom (DOF) are zero when the targeted variable is investigated for simplification of discussions. That is to say, when xₐ is the objective variable, the variables zₐ and ψₐ in the vertical and rotational directions are equal to zero. In this case, Equations 34a to 34c can be written as Equations 36a to 36c where Equations 37a and 37b apply.

M\ddot{x}ₐ+c₁ₓ\dot{x}ₐ+2c₂ₓf_{cx}(xₐ)\dot{x}ₐ+fₙₓ(xₐ)=−M\ddot{x}_{b}, (36a)

M\ddot{z}ₐ+c₁ₓżₐ+2c_{2z}f_{cz}(zₐ)żₐ+f_{nz}(zₐ)=−M\ddot{z}_{b}, (36b)

J\ddot{ψ}ₐ+c_{1ψ}\dot{ψ}ₐ+2c_{2ψ}f_{cψ}(ψₐ)\dot{ψ}ₐ+f_{nψ}(ψₐ)=−J\ddot{ψ}_{b}, (36c)

fₙₓ(xₐ)=fₙₓ|_{z}_{ₐ}_{=0,ψ}_{ₐ}₌₀,f_{nz}(zₐ)=f_{nz}|ₓ_{ₐ}_{=0,ψ}_{ₐ}₌₀,f_{nψ}(ψₐ)=f_{nψ}|_{z}_{ₐ}_{=0,x}_{ₐ}₌₀, (37a)

f_{cx}(xₐ)=f_{cx}|_{z}_{ₐ}_{=0,ψ}_{ₐ}₌₀,f_{cz}(zₐ)=f_{cz}|ₓ_{ₐ}_{=0,ψ}_{ₐ}₌₀,f_{cψ}(ψₐ)=f_{cψ}|_{z}_{ₐ}_{=0,x}_{ₐ}₌₀. (37b)

If the vibration isolation unit 100 is linear, the stiffness is independent of the static equilibrium position. But for the nonlinear vibration isolation unit 100, the static equilibrium position has a great influence on the structural stiffness. Thus, the static equilibrium position is selected as the original point, and the displacements xₛ, zₛ and ψₛ of the static equilibrium position in the x, z and ψ directions are expressed by Equation 38 where xₛₜ, zₛₜ and ψₛₜ denote the static deformations of the vibration isolation unit 100 due to the isolation object.

xₛ=xₐ−xₛₜ, zₛ=zₐ−zₛₜ, ψₛ=ψₐ−ψₛₜ (38)

Substituting Equation 38 into Equations 36a to 36c, the decoupled nonlinear equations of motion of the vibration isolation unit 100 can be further written as Equations 39a to 39c.

M\ddot{x}ₛ+c₁ₓ\dot{x}ₛ+2c₂ₓf_{cx}(xₛ)\dot{x}ₛ+fₙₓ(xₛ)=−M\ddot{x}_{b}, (39a)

M\ddot{z}ₛ+c_{1z}żₛ+2c_{2z}f_{cz}(zₛ)żₛ+f_{nz}(zₛ)=−M\ddot{z}_{b}, (39b)

J\ddot{ψ}ₛ+c_{1ψ}\dot{ψ}ₛ+2c_{2ψ}f_{cψ}(ψₛ)\dot{ψ}ₛ+f_{nψ}(ψₛ)=−J\ddot{ψ}_{b}. (39c)

Because some expressions in the nonlinear equations of motion for the vibration isolation unit 100 are fractional and extremely complicated, Equations 39a to 39c cannot be theoretically solved. Therefore, polynomial fitting is used to transfer the fractional items into polynomial functions, and the nonlinear restoring force and damping functions fₙₓ(xₛ), f_{nz}(zₛ), f_{nψ}(ψₛ), f_{cx}(xₛ), f_{cz}(zₛ) and f_{cψ}(ψₛ) can be expressed as

\hat{f}ₙₓ(xₛ)=ζₓ₁xₛ+ζₓ₂xₛ²+ζₓ₃xₛ³+ζₓ₄xₛ⁴, (40a)

\hat{f}_{nz}(zₛ)=ζ_{z1}zₛ+ζ_{z2}zₛ²+ζ_{z3}zₛ³+ζ_{z4}zₛ⁴, (40b)

\hat{f}_{nψ}(ψₛ)=ζ_{ψ1}ψₛ+ζ_{ψ2}ψₛ²+ζ_{ψ3}ψₛ³+ζ_{ψ4}ψₛ⁴, (40c)

\hat{f}_{cx}(xₛ)=χₓ₀+χₓ₁xₛ+χₓ₂xₛ²+χₓ₃xₛ³+χₓ₄xₛ⁴, (40d)

\hat{f}_{cz}(zₛ)=χ_{z0}+χ_{z1}zₛ+χ_{z2}zₛ²+χ_{z3}zₛ³+χ_{z4}zₛ⁴, (40e)

\hat{f}_{cψ}(ψₛ)=χ_{ψ0}+χ_{ψ1}ψₛ+χ_{ψ2}ψₛ²+χ_{ψ3}ψₛ³+χ_{ψ4}ψₛ⁴. (40f)

To evaluate the accuracy of the polynomial fitting, the comparison of the original nonlinear stiffness and damping functions fₙₓ(xₛ), f_{nz}(zₛ), f_{nψ}(ψₛ), f_{cx}(xₛ), f_{cz}(zₛ) and f_{cψ}(ψₛ) and the 3rd order and 4th order polynomial fitting results were investigated. The structural parameters of the vibration isolation unit 100 were taken as: kᵤ=400 N/m, kₘ=400 N/m, kₗ=2000 N/m, L₁=0.1 m, L₂=0.12 m, L₃=0.05 m, L₄=0.03 m, γ₁=π/3, θ₂=π/4, α=0.2 and β=0.2. The inventors observed that the results of the 3rd order polynomial fitting were somewhat different from the original functions, especially for the nonlinear damping functions f_{cx}(xₛ) and f_{cψ}(ψₛ). The results of the 4th order polynomial fitting were consistent with the original nonlinear stiffness and damping functions, which demonstrated the correctness and rationality of the 4th order polynomial fitting results in the given displacement range.

Substituting Equations 40a to 40f into Equations 39a to 39c, the nonlinear equations of motion of the vibration isolation unit 100 can be further expressed as Equations 41a to 41c.

M\ddot{x}ₛ+c₁ₓ\dot{x}ₛ+2c₂ₓ(χₓ₀+χₓ₁xₛ+χₓ₂xₛ²+χₓ₃xₛ³+χₓ₄xₛ⁴)\dot{x}ₛ+ζₓ₁xₛ+ζₓ₂xₛ²+ζₓ₃xₛ³+ζₓ₄xₛ⁴=−M\ddot{x}_{b}, (41a)

M\ddot{z}ₛ+c_{1z}żₛ+2c_{2z}(χ_{z0}+χ_{z1}zₛ+χ_{z2}zₛ²+χ_{z3}zₛ³+χ_{z4}zₛ⁴)żₛ+ζ_{z1}zₛ+ζ_{z2}zₛ²+ζ_{z3}zₛ³+ζ_{z4}zₛ⁴=−M\ddot{z}_{b}, (41b)

J\ddot{ψ}ₛ+c_{1ψ}\dot{ψ}ₛ+2c_{2ψ}(χ_{ψ0}+χ_{ψ1}ψₛ+χ_{ψ2}ψₛ²+χ_{ψ3}ψₛ³+χ_{ψ4}ψₛ⁴)\dot{ψ}ₛ+ζ_{ψ1}ψₛ+ζ_{ψ2}ψₛ²+ζ_{ψ3}ψₛ³+ζ_{ψ4}ψₛ⁴=−J\ddot{ψ}_{b}. (41c)

For convenience, the nonlinear equations of motion of the proposed vibration isolation unit in the three directions can be uniformly written as Equation 42.

ÿ+κ₀\dot{y}+κ₁y\dot{y}+κ₂y²\dot{y}+κ₃y³\dot{y}+κ₄y⁴\dot{y}+μ₁y+μ₂y²+μ₃y³+μ₄y⁴=−ÿ_{b}. (42)

Assuming that the base excitation in the vertical direction is z_{b}=z₀ cos(2πft), the nonlinear equation of motion, Equation 41b, can be solved through the multiple scales method, and the steady-state responses for the vibration isolation unit 100 in the z-direction can be obtained. The displacement y can be assumed in the form of trigonometric function as Equation 43 where a₁ and ϑ denote the amplitude of the motion and phase angle. Therefore, the absolute displacement transmissibility T_{z} can be expressed as Equation 44.

$$y = {a}_{1} cos ( 2 π ft + ϑ ) , \qquad ( 43 )$$

$${T}_{z} = \frac{\sqrt{{a}_{1}^{2} + {z}_{0}^{2} + 2 {a}_{1} {z}_{0} cos ϑ}}{\vert {z}_{0} \vert} . \qquad ( 44 )$$

Using the same method, the absolute displacement transmissibility Tₓ and T_{ψ} of the vibration isolation unit 100 under base excitations x_{b}=x₀ cos(2πft) and ψ_{b}=ψ₀ cos(2πft) in the other two DOFs can be calculated by Equation 45.

$${T}_{x} = \frac{\sqrt{{a}_{1}^{2} + {x}_{0}^{2} + 2 {a}_{1} {x}_{0} cos ϑ}}{\vert {x}_{0} \vert} , {T}_{ψ} = \frac{\sqrt{{a}_{1}^{2} + {ψ}_{0}^{2} + 2 {a}_{1} {ψ}_{0} cos ϑ}}{\vert {ψ}_{0} \vert} . \qquad ( 45 )$$

The static analyses of the static stiffness, loading capacity and QZS property of the vibration isolation unit 100 along three directions were investigated. The structural parameters such as the initial assembly angles, lengths of the rods, spring connection parameters α and β, stiffness kᵤ, kₘ and kₗ of the springs can all be tuned to achieve different static stiffness performances. In one example, the structural parameters of the vibration isolation unit 100 in this discussion are supposed to be fixed as: kᵤ=400 N/m, kₘ=400 N/m, kₗ=2000 N/m, L₁=0.1 m, L₂=0.12 m, L₃=0.05 m, L₄=0.03 m, θ₁=π/3, θ₂=π/4, α=0.2 and β=0.2.

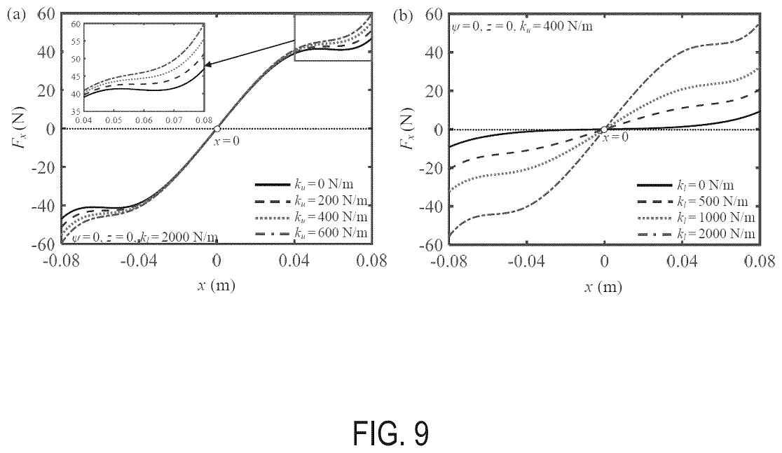

FIG. 9 shows the nonlinear force-displacement curves Fₓ of the vibration isolation unit 100 under different spring stiffness kᵤ and kₗ. It can be seen from FIG. 9(a) that the vibration isolation unit 100 with kᵤ=0 N/m exhibits different stiffness values, which are positive, zero and negative. The equivalent stiffness of the unit with kᵤ=200 N/m is nonlinear and changed from a positive value, via quasi-zero and to a positive value. Moreover, the vibration isolation unit 100 with kᵤ=400 N/m and 600 N/m exhibits positive stiffness throughout the stroke, which means that the whole motion range is within the effective working range. Additionally, it is noted from FIG. 9(b) that with the increase of kₗ, the loading capacity of the vibration isolation unit 100 increases significantly with larger stiffness in the x-direction. The vibration isolation unit 100 with kₗ=2000 N/m exhibits QZS characteristics with a large loading capacity, which is beneficial to the design of the QZS isolators. Under different spring stiffness kₗ, the vibration isolation unit 100 always exhibits positive and quasi-zero stiffness properties, which indicates the whole motion range of the vibration isolation unit 100 is in the effective working range.

It should be noted that, in FIG. 9, only the influences of Kᵤ and Kₗ on the nonlinear force-displacement curves are considered. The influence of Kₘ on the nonlinear force-displacement curve of the structure is actually similar to that of Kᵤ.

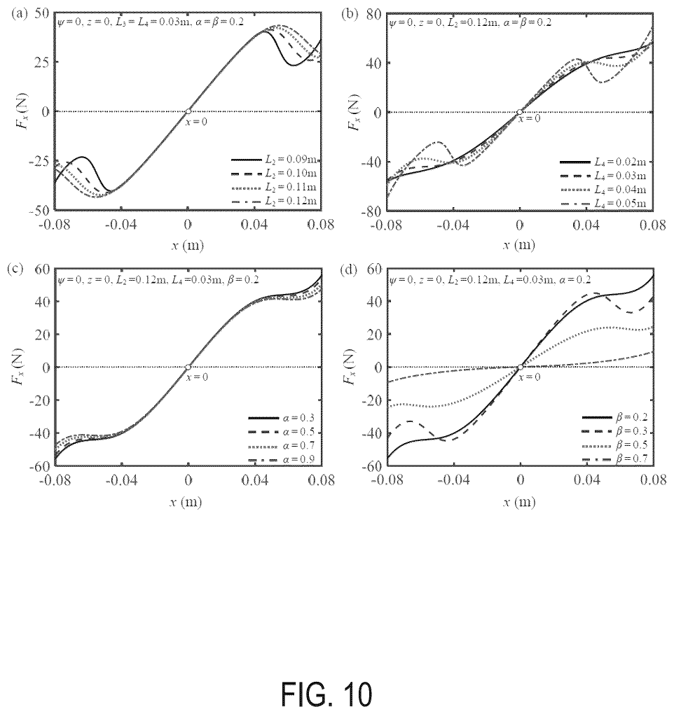

The influences of the lengths L₂ and L₄ of rods and the spring connection parameters α and β on the nonlinear force-displacement curves F of the vibration isolation unit 100 are displayed in FIG. 10. It can be noticed from FIG. 10(a) that, with the increase of the displacement x, the equivalent stiffness changes from a positive value to a negative value via zero stiffness, and a larger L₂ results in a higher loading capacity. The effective working zones of the unit with L₂=0.09 m, 0.10 m, 0.11 m and 0.12 m are in the ranges −0.046 m≤x≤0.046 m, −0.05 m≤x≤0.05 m, −0.053 m≤x≤0.053 m and −0.055 m≤x≤0.055 m, which means that a larger L₂ leads to a wider effective working range. Besides, under different lengths L₂ of rods, the stiffness of the vibration isolation unit 100 can be flexibly changed from positive, zero to negative stiffness.

FIG. 10(b) shows the force-displacement relationships of the unit 100 with different lengths L₄. It is found that the structure with L₄=0.02 m exhibits positive stiffness throughout the stroke, the structure with L₄=0.03 m exhibits quasi-zero stiffness, and the structure with L₄=0.04 m and 0.05 m can achieve the negative stiffness property and snap-through phenomenon. The force-displacement curves of the unit 100 with different spring connection parameters α are shown in FIG. 10(c), in which the nonlinear stiffness characteristic similar to the FIG. 9(a) is observed and decreasing the spring connection parameter α can improve the equivalent stiffness and loading capacity of the unit in the x-direction. In addition, it can be observed from FIG. 10(d) that with the increase of the spring connection parameter β, the loading capacity of the vibration isolation unit decreases significantly in the x-direction, and the unit with β=0.2 exhibits large loading capacity and QZS effect with large stroke.

It is noted that, since the vibration isolation unit 100 contains many structural parameters, representative parameters such as L₂ and L₄ are selected to investigate their influence on the static stiffness characteristic and vibration isolation performance. The influences of L₁ and L₃ on the vibration isolation performance of the vibration isolation unit 100 are similar to those of L₂ and L₄.

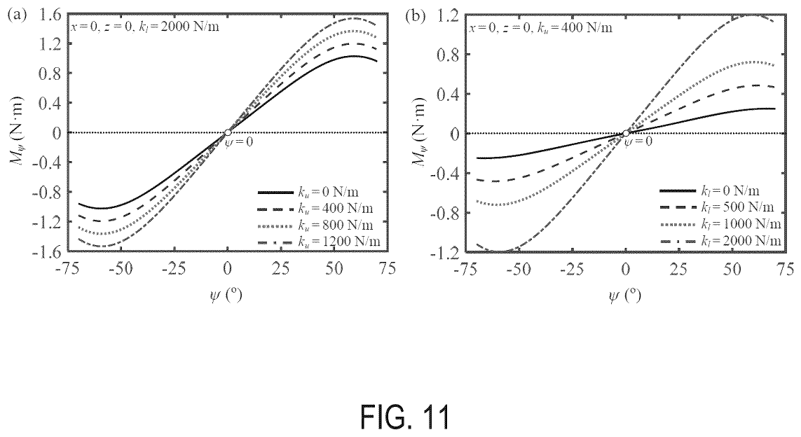

FIG. 11 displays the effect of the spring stiffness kᵤ and kₗ on the nonlinear bending moment and rotation angle curves of the vibration isolation unit 100. It is observed from FIG. 11(a) that the vibration isolation unit 100 with different spring stiffness kᵤ exhibits different stiffness values, including positive, zero or quasi-zero and negative. With the increase of the spring stiffness kᵤ, the loading capacity increases with larger stiffness in the rotational direction, and the width of the QZS zone decreases. The effective working zones of the vibration isolation unit 100 with different spring stiffness kᵤ are almost the same. Additionally, it can be found from FIG. 11(b) that, with the increase of the spring stiffness kₗ, the loading capacity increases significantly, but the effective working range decreases slightly.

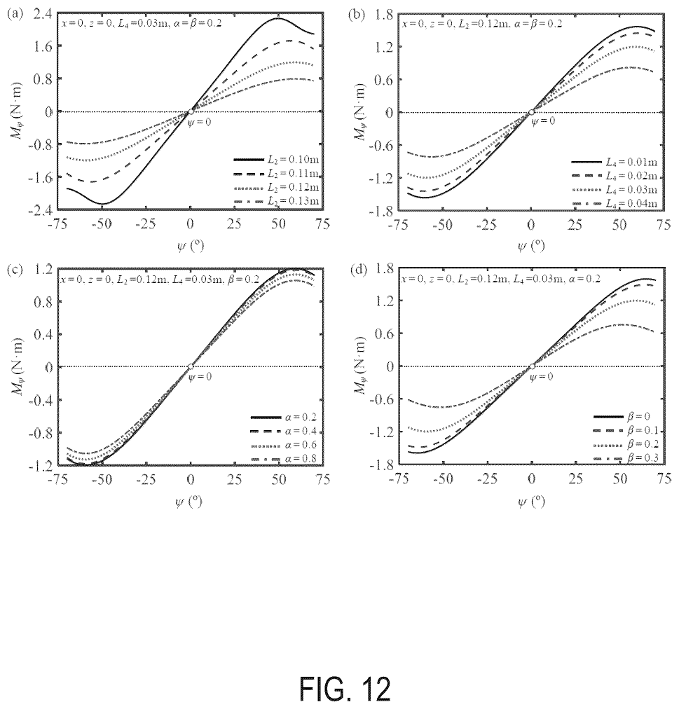

The bending moment and rotation angle curves of the vibration isolation unit 100 with different lengths L₂ and L₄ of rods and different spring connection parameters α and β are displayed in FIG. 12. FIG. 12(a) shows the influence of the length L₂ of rods on the nonlinear bending moment and rotation angle curves of the unit 100. It can be noted that the vibration isolation unit 100 with different L₂ exhibits different stiffness values. The loading capacity of the vibration isolation unit 100 decreases with the increase of L₂, and different QZS zones of the structure under different L₂ can be easily obtained. Additionally, the effective working zones of the unit 100 with L₂=0.10 m, 0.11 m, 0.12 m and 0.13 m are in the ranges −50°≤ψ≤50°, −56°≤ψ≤56°, −59°≤ψ≤590 and −61°≤ψ≤61°, which demonstrates that a lager rod length L₂ results in a wider effective working range. Moreover, it is observed from FIG. 12(b) that, with the rod length L₄ increasing, the loading capacity of the structure decreases, and the effective working range decreases slightly. FIGS. 12(c) and 12(d) exhibit the influences of the spring connection parameters α and β on the nonlinear bending moment and rotation angle curves of the vibration isolation unit 100. It can be found that the beneficial nonlinear stiffness characteristics similar to FIG. 12(a) can be maintained and tuning the spring connection parameters α and β can effectively improve the stiffness and loading capacity and obtain different QZS characteristics, which is beneficial to the design of nonlinear QZS isolators.

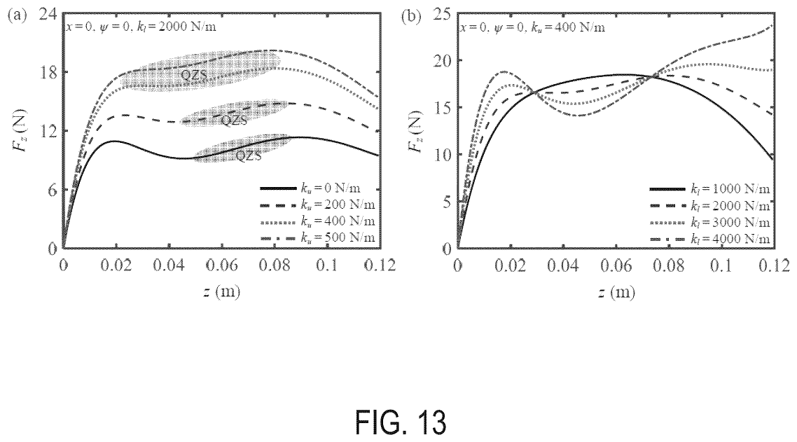

FIG. 13 shows the vertical nonlinear force-displacement curves of the vibration isolation unit 100 under different spring stiffness kᵤ and kₗ. It is seen from FIG. 13(a) that the loading capacity of the vibration isolation unit 100 increases with the increase of the spring stiffness kᵤ, and different QZS zones of the structure under different spring stiffness kᵤ can be easily achieved. The springs with stiffness kᵤ in the upper of the structure can enhance the loading capacity while maintaining high static and low dynamic stiffness behaviors, which is very beneficial to realize low frequency vibration isolation. The influence of the spring stiffness kₗ on the nonlinear force-displacement relationship of the unit 100 is shown in FIG. 13(b), where negative, quasi-zero, positive stiffness and snap-through response in a certain range can be observed under different spring stiffness kₗ. Specifically, the vibration isolation unit with kₗ=2000 N/m exhibits QZS property, and the unit with kₗ=3000 N/m and 4000 N/m exhibits snap-through response property.

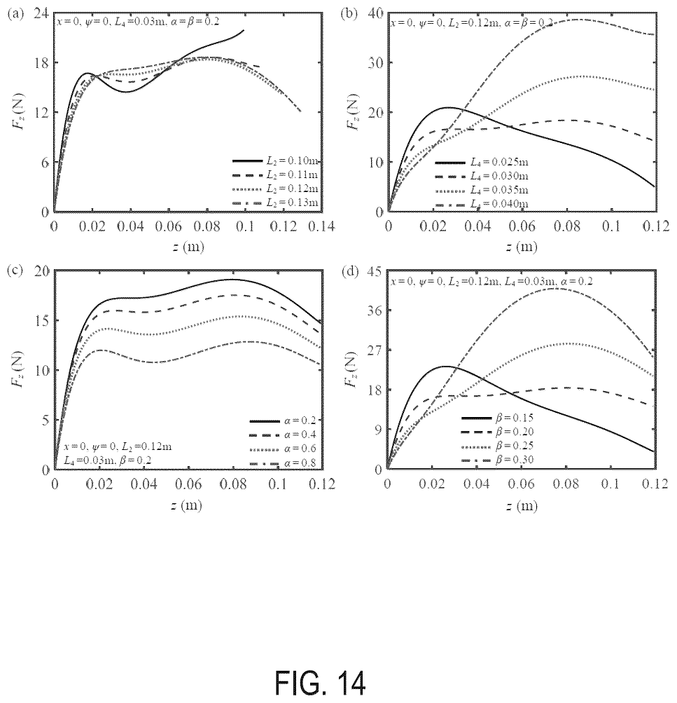

The nonlinear force-displacement curves of the vibration isolation unit 100 under different lengths L₂ and L₄, and different spring connection parameters α and β are presented in FIG. 14. It is noted from FIG. 14(a) that the effective stroke of the unit increases with the increase of the rod length L₂. In addition, the vibration isolation unit 100 with L₂=0.10 m and 0.11 m exhibits snap-through response property, and the structure with L₂=0.12 m and 0.13 m exhibits QZS property with large stroke. FIG. 14(b) exhibits the effect of the rod length L₄ on the nonlinear force-displacement curves. It was found that the vibration isolation unit 100 with different L₄ exhibits positive, zero or quasi-zero and negative stiffness values. The different loading capacities and QZS zones of the proposed vibration isolation unit 100 can be easily achieved by adjusting the rod length L₄. The influences of the spring connection parameters α and β on the nonlinear force-displacement curves of the unit are evaluated and displayed in FIGS. 14(c) and 14(d). It can be noticed that the beneficial nonlinear stiffness properties similar to the FIGS. 13(a) and 14(b) can be maintained and adjusting the spring connection parameters α and β can effectively improve the stiffness and loading capacity and obtain different QZS characteristics.

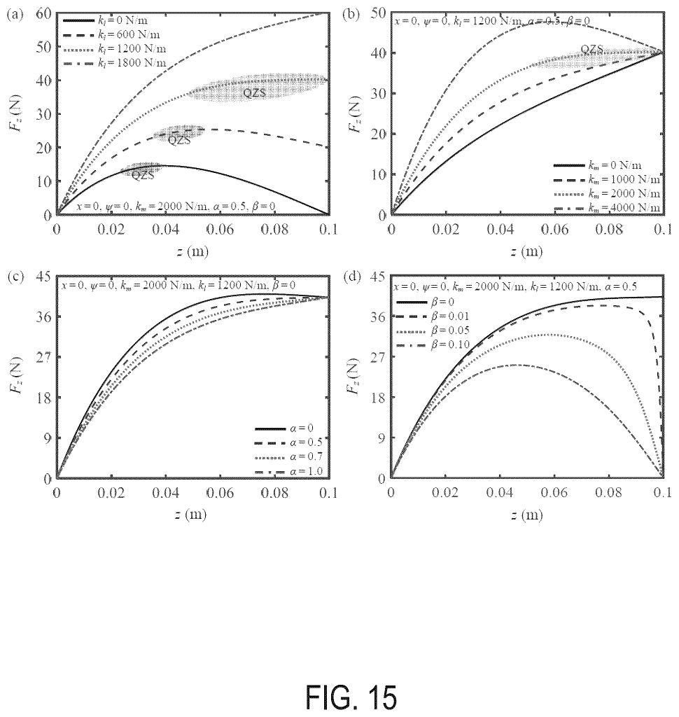

For the structural parameters L₁=L₂=0.1 m, L₃=0.4 m, L₄=0.0212 m, kᵤ=1600 N/m, θ₁=θ₂=π/6, FIG. 15 displays the influences of the spring stiffness kₗ and kₘ, and the spring connection parameters α and β on the force-displacement curve F. It can be observed from FIG. 15(a) that the unit 100 with kₗ==0 N/m and 600 N/m exhibits negative stiffness with small QZS zones, the unit 100 with kₗ=1200 N/m exhibits QZS property with large stroke, and the unit 100 with kₗ=1800 N/m exhibits positive stiffness characteristic throughout the whole stroke. Moreover, with spring stiffness kₗ increasing, the negative stiffness gradually increases to zero and positive stiffness, and the QZS zone of the unit 100 with kₗ=1200 N/m is larger than those of the unit 100 with other spring stiffness. Therefore, the springs with stiffness k may enhance the loading capacity and may maintain high static and low dynamic stiffness properties, which is beneficial to the design of nonlinear vibration isolators. FIG. 15(b) displays the force-displacement relationships of the unit under different kₘ. It can be observed that, with the increase of the spring stiffness kₘ, the equivalent stiffness increases significantly in the initial stage of the vertical displacement and decreases obviously in the later stage, which means that excellent high static and low dynamic stiffness behaviors can be achieved by adjusting the spring stiffness kₘ.

Additionally, the effect of the spring connection parameter α on the force-displacement curves is displayed in FIG. 15(c), in which the nonlinear static stiffness behaviors similar to FIG. 15(b) can be clearly observed and decreasing the spring connection parameter α can effectively enhance the equivalent stiffness and the loading capacity in the vertical direction. The force-displacement relationship of the unit 100 under different spring connection parameters β is shown in FIG. 15(d). The points D₁ and E₁ in the left side of the unit 100 coincide and the points D₄ and E₂ in the right side of the unit 100 also coincide at the maximum stroke position, and the two springs with stiffness kₗ are fully compressed in the vertical direction when the spring connection parameter β=0. However, when the spring connection parameter β is greater than 0, the two springs with stiffness kₗ are horizontal at the maximum stroke position, and no vertical force is provided to the structure at this time. Accordingly, it can be seen from FIG. 15(d) that the unit 100 with β=0.01, 0.05 and 0.1 has negative stiffness with small QZS zones and the unit 100 with β=0 exhibits a QZS effect with large stroke.

The inventors also evaluated the vibration isolation performance of the vibration isolation unit 100 along different directions according to the absolute displacement transmissibility. The influences of different structural parameters including the lengths of the rods, the equivalent linear damping coefficient, the rotational fiction damping coefficient, the spring stiffness and the spring connection parameters on the displacement transmissibility were evaluated to achieve better vibration isolation performance. In this example, the structural parameters of the vibration isolation unit 100, the external excitation amplitudes and the damping coefficients in this discussion are taken as: kᵤ=400 N/m, kₘ=400 N/m, kₗ=2000 N/m, L₁=0.1 m, L₂=0.12 m, L₃=0.05 m, L₄=0.03 m, θ₁=π/3, θ₂=π/4, α=0.2, β=0.2, ψ=0.002 m, ψ₀=0.05 rad, z₀=0.002 m, c₁ₓ=5 N·s/m, c₂ₓ=0.05 N·s/m, c_{1ψ}=0.1 N·m·s/rad, c_{2ψ}=0.05 N·m·s/rad, c_{1z}=2 N·s/m and c_{2z}=0.02 N·s/m.

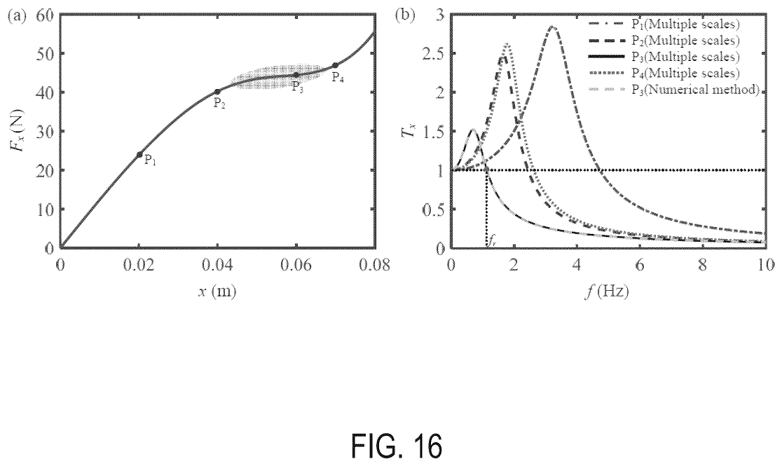

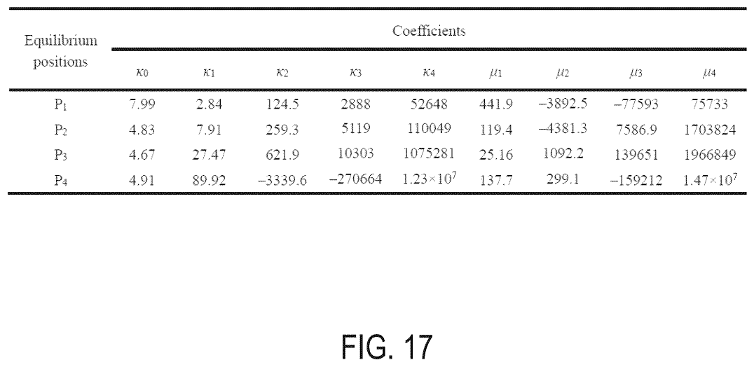

The force-displacement relationship curve and displacement transmissibility of the vibration isolation unit 100 in the x-direction under four different equilibrium positions P₁ (xₛₜ=0.02 m), P₂ (xₛₜ=0.04 m), P₃ (xₛₜ=0.06 m) and P₄ (xₛₜ=0.07 m) are displayed in FIG. 16, and the corresponding values of the coefficients κ₀ (N·s·m⁻¹·kg⁻¹), κ₁ (N·s·m⁻²·kg⁻¹), κ₂ (N·s·m⁻³·kg⁻¹), κ₃ (N·s·m⁻⁴·kg⁻¹), κ₄ (N·s·m⁻⁵·s·m⁻⁵·kg⁻¹), μ₁ (N·m⁻¹·kg⁻¹), μ₂ (N·m⁻²·kg⁻¹), μ₃ (N·m⁻³·kg⁻¹) and μ₄ (N·m⁻⁴·kg⁻¹) of the polynomials used for fitting the stiffness and damping characteristics are also calculated and shown in the table of FIG. 17. Moreover, the accuracy of the present multiple scales formulation is verified by the numerical method. FIG. 16(b) also presents the displacement transmissibility Tₓ of the vibration isolation unit 100 under equilibrium position P₃ acquired through the numerical integration and multiple scales method. It is noted that the results are in good agreement, which implies the accuracy and feasibility of the multiple scales method.

The loading capacity in the x-direction increases from position P₁ to P₄, and the corresponding stiffness decrease first and then increases from P₁ to P₄. The resonant frequencies with equilibrium positions P₁, P₂ and P₄ are 3.32 Hz, 1.65 Hz and 1.79 Hz, and the resonant peaks of the transmissibility are about 2.84, 2.49 and 2.62. When the excitation frequencies in the x-direction are greater than 4.72 Hz, 2.45 Hz and 2.65 Hz, the displacement transmissibility is less than 1 and the unit 100 starts to attenuate vibration. Additionally, it is found from FIG. 16(b) that when the point P₃ in the QZS zone is taken as the equilibrium position, the corresponding resonant frequency is 0.71 Hz, which is much lower than those of the unit 100 with equilibrium positions P₁, P₂ and P₄. The vibration isolation unit 100 with equilibrium position P₃ can attenuate vibration when the base excitation frequency is larger than 1.15 Hz, which can achieve ultra-low frequency vibration isolation and widen the vibration isolation band. Besides, with the excitation frequency increasing, the displacement transmissibility is reduced to 0.5 at about 1.82 Hz, which indicates that the vibration isolation performance of the unit 100 with equilibrium position in the state of QZS is better than the results of the unit 100 with equilibrium positions P₁, P₂ and P₄.

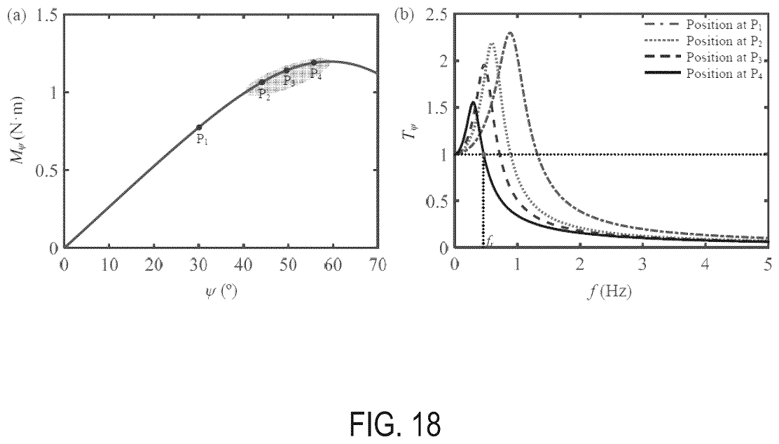

FIG. 18 shows the vibration isolation performance of the vibration isolation unit 100 in the ψ-direction under four different equilibrium positions P₁ (ψₛₜ=π/6), P₂ (ψₛₜ=π/4), P₃ (ψₛₜ=5π/18) and P₄ (ψₛₜ=11π/36). It can be seen that the equilibrium positions P₂, P₃ and P₄ are in the state of QZS, and the loading capacity of the unit 100 in the ψ-direction increases and the corresponding stiffness decreases from P₁ to P₄. The vibration isolation frequencies of the unit 100 in the ψ-direction under equilibrium positions P₁, P₂, P₃ and P₄ are equal to 1.32 Hz, 0.91 Hz, 0.72 Hz and 0.46 Hz, respectively. Additionally, the resonant frequency and resonant peak of the unit 100 under equilibrium position P₄ are lower than those of the unit 100 under equilibrium positions P₁, P₂ and P₃, which means that the unit 100 under equilibrium position P₄ exhibits a wider range of effective vibration isolation frequency. That is to say, the unit 100 can conveniently achieve excellent vibration isolation performance in the ψ-direction.

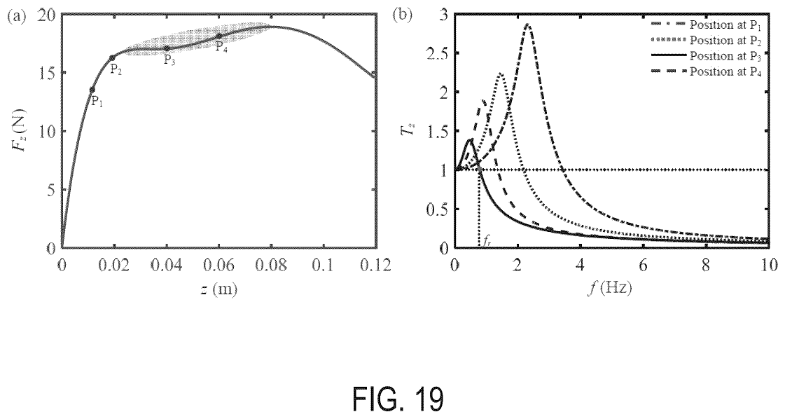

The nonlinear force-displacement relationship curve and displacement transmissibility of the vibration isolation unit 100 in the vertical direction under four different equilibrium positions P₁ (zₛₜ=0.015 m), P₂ (zₛₜ=0.02 m), P₃ (zₛₜ=0.04 m) and P₄ (zₛₜ=0.06 m) are calculated and exhibited in FIG. 19. It can be found from FIG. 19(a) that the loading capacity increases from equilibrium position P₁ to P₄, and the equilibrium positions P₃ and P₄ are in the state of QZS. That is to say, the high static and low dynamic stiffness characteristics of the vibration isolation unit 100 in the z-direction can be achieved flexibly. FIG. 19(b) displays the vibration isolation performance of the unit 100 in the z-direction under different equilibrium positions. It can be observed that the corresponding resonant peaks of the unit 100 with equilibrium positions P₁ and P₂ are about 2.86 and 2.23, and the vibration isolation frequencies are 3.45 Hz and 2.20 Hz, which means that the unit 100 with equilibrium positions P₁ and P₂ starts to attenuate vibration after 3.45 Hz and 2.20 Hz. When P₃ and P₄ in the state of QZS are selected as the equilibrium positions, the corresponding vibration isolation frequencies and resonant peaks are much lower than those of the unit 100 with equilibrium positions P₁ and P₂. For the vibration isolation unit 100, a QZS with a large stroke can be obtained, and the vibration isolation frequency and resonant peak can be suppressed by adjusting the structural parameters.

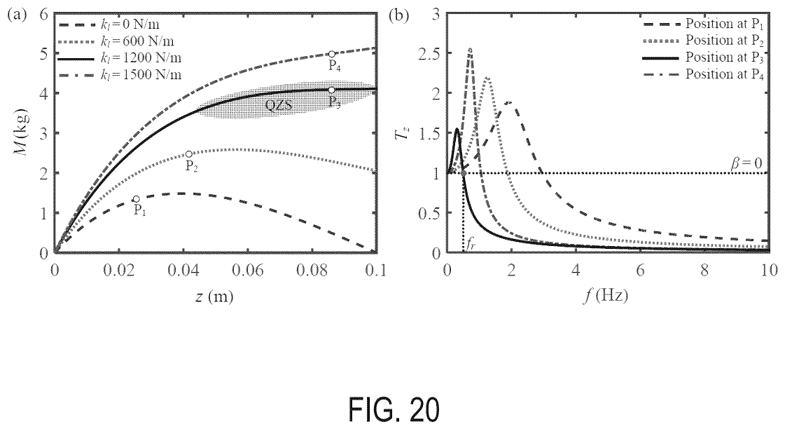

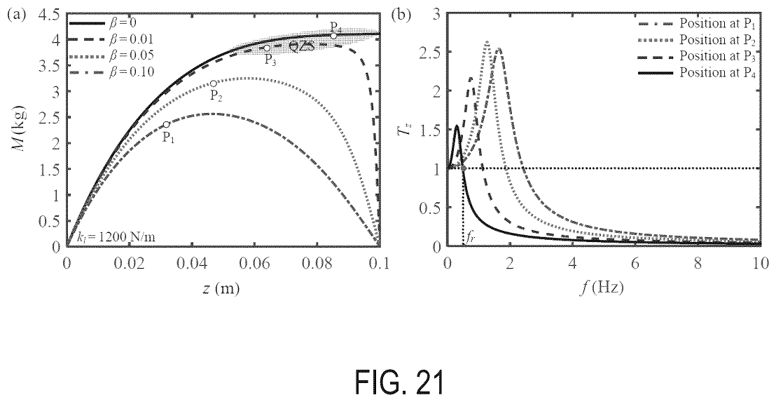

For the structural parameters L₁=L₂=0.1 m, L₃=0.4 m, L₄=0.0212 m, kᵤ=1600 N/m, kₘ=2000 N/m, θ₁=θ₂=π/6 and α=0.5, FIGS. 20 and 21 display the variations of the isolated mass with equilibrium position and the displacement transmissibility of the vibration isolation unit 100 in the vertical direction under different spring stiffness kₗ and connection parameters β. It can be found from FIG. 20 that the equilibrium positions of the unit 100 with kₗ=0 N/m, 600 N/m, 1200 N/m and 1500 N/m are P₁ (zₛₜ=0.025 m), P₂ (zₛₜ=0.041 m), P₃ (zₛₜ=0.085 m) and P₄ (zₛₜ=0.085 m), and the loading capacity increases from points P₁ to P₄. The resonant frequencies of the vibration isolation unit 100 under equilibrium positions P₁, P₂, P₃ and P₄ are equal to 1.90 Hz, 1.25 Hz, 0.30 Hz and 0.71 Hz, and the corresponding isolation frequencies are about 2.95 Hz, 1.88 Hz, 0.49 Hz and 1.05 Hz. Moreover, the resonant peak under equilibrium position P₃ is much lower than those of the unit 100 under equilibrium positions P₁, P₂ and P₄. Thus, it can be concluded that the unit 100 with spring stiffness kₗ=1200 N/m exhibits better vibration isolation performance in the vertical direction.

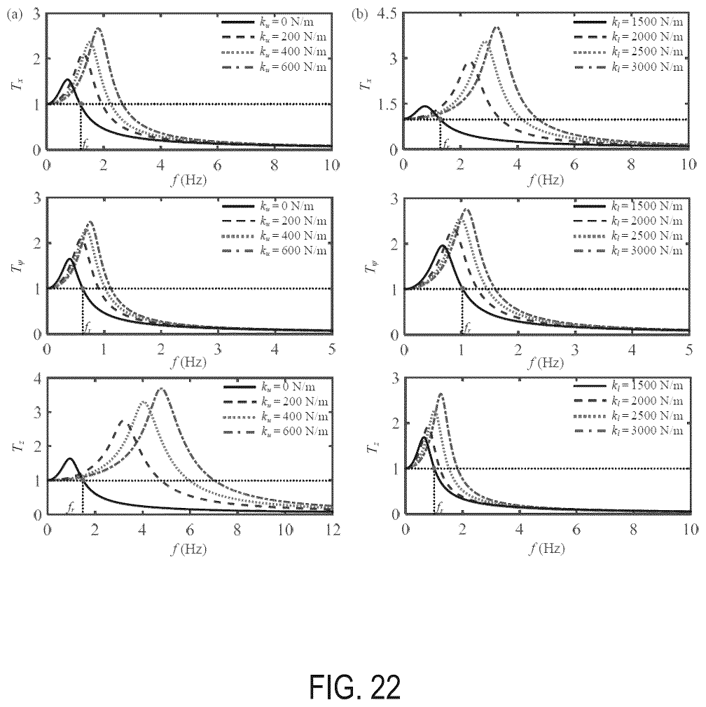

The influences of the spring stiffness kᵤ and kₗ on the vibration isolation performance of the unit 100 in the three directions were evaluated. FIG. 22 displays the displacement transmissibility of the vibration isolation unit 100 in the horizontal, rotational and vertical directions with different spring stiffness kᵤ and kₗ. For the unit 100 with different kᵤ, the preloads corresponding to the horizontal, rotational and vertical static equilibrium positions are Fₓ=41 N, M_{ψ}=1 N·m and F_{z}=11 N. It is found from FIG. 22(a) that the influence of the spring stiffness kᵤ on the displacement transmissibility of the unit is as expected. For the isolation performance in the x-direction, the resonant frequencies of the vibration isolation unit 100 with kᵤ=0 N/m, 200 N/m, 400 N/m and 600 N/m are 0.74 Hz, 1.30 Hz, 1.52 Hz and 1.81 Hz, and the resonant peaks of the unit are about 1.54, 2.11, 2.35 and 2.67, respectively. That is to say, the resonant frequency and resonant peak of the unit 100 become lower with the decreasing spring stiffness kᵤ. The unit 100 possessed the best vibration isolation performance without the linear springs “2” and “3” in the upper layer of the unit, and in some embodiments, might not include the springs “2” and “3”.

For the rotational and vertical directions as displayed in FIG. 22(a), the proposed vibration isolation unit 100 with a small spring stiffness kᵤ also exhibits lower resonant frequency and resonant peak, which means that the smaller spring stiffness kᵤ benefits the vibration isolation performance in all three directions. The preloads corresponding to the horizontal, rotational and vertical static equilibrium positions are Fₓ=34 N, M_{ψ}=0.8 N·m and F_{z}=18 N, and the vibration isolation performance for the unit 100 under different kₗ is exhibited in FIG. 22(b), in which the vibration isolation performance similar to the FIG. 22(a) can be observed and decreasing the spring stiffness kₗ can effectively decrease the resonant frequency, isolation frequency and resonant peak of the unit in all of DOF directions.

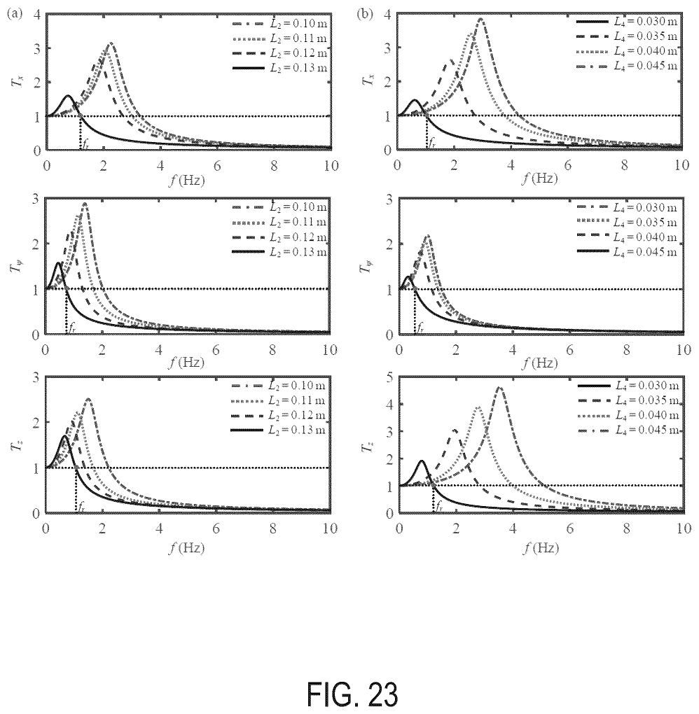

The vibration isolation performance of the unit 100 in all three directions under different rod lengths L₂ and L₄ was investigated and the results shown in FIG. 23. To illustrate the vibration isolation performance, it was uniformly assumed that the preloads of the unit 100 with different rod lengths L₂ are Fₓ=47 N, M_{ψ}=0.75 N·m and F_{z}=17.5 N in the three directions. It can be found from FIG. 23(a) that the resonant frequencies, the resonant peaks and the vibration isolation frequencies of the unit 100 in all three directions become smaller with the increasing rod length L₂. Taking the displacement transmissibility in the vertical direction as an example, the resonant frequency, the resonant peak and the vibration isolation frequency of the unit 100 with L₂=0.10 m are about 1.51 Hz, 2.5 and 2.22 Hz. When L₂=0.11 m and 0.12 m, the resonant frequencies are decreased to 1.11 Hz and 0.91 Hz, and the resonant peaks are about 2.2 and 2. The resonant and isolation frequencies are further reduced to about 0.65 Hz and 1.05 Hz when L₂=0.13 m and the resonant peak is about 1.7, which is much lower than those of the unit 100 with other rod lengths. That is to say, the unit 100 with rod length L₂=0.13 m exhibits a wider range of vibration isolation frequency in all DOF directions. For the unit 100 with different rod lengths L₄, the preloads corresponding to the horizontal, rotational and vertical static equilibrium positions are Fₓ=44 N, M_{ψ}=0.64 N·m and F_{z}=18 N. It is observed from FIG. 23(b) that the resonant frequency and resonant peak of x and z are larger when the rod length L₄ becomes larger, while the vibration isolation performance in the ψ-direction is better due to its lower resonant frequency, lower resonant peak and wider vibration isolation band.

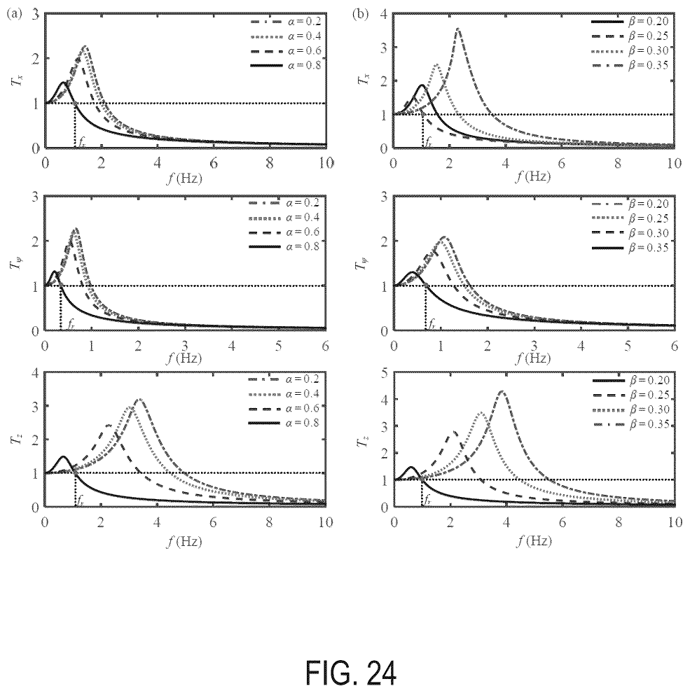

FIG. 24 displays the absolute displacement transmissibility of the vibration isolation unit 100 in the horizontal, rotational and vertical directions with different parameters α and β. For the unit 100 with different parameters α, it is uniformly assumed that the preloads of the unit 100 corresponding to the vertical, horizontal and rotational static equilibrium positions are Fₓ=41.6 N, M_{ψ}=1.05 N·m and F_{z}=12.6 N. It is observed from FIG. 24(a) that the resonant frequency and the resonant peak in all three directions become smaller with the increasing parameter α, and the width of the vibration isolation band increases. Therefore, the vibration isolation performance for the unit 100 in three directions can be effectively enhanced by adjusting parameter α. For the unit 100 with different parameters β, the preloads corresponding to the vertical, horizontal and rotational static equilibrium positions are Fₓ=43 N, M_{ψ}=0.55 N·m and F_{z}=18.2N. As displayed in FIG. 24(b), the parameter β can significantly influence the absolute displacement transmissibility of the unit 100 in all three directions, and the unit 100 with β=0.25 in the x-direction has a smaller resonant frequency, lower resonant peak and wider vibration isolation band. Additionally, when the parameter β becomes smaller, the resonant frequency and resonant peak of ψ are larger, while the resonant frequency, vibration isolation frequency and absolute displacement transmissibility in the vertical direction sharply decrease. That is to say, the unit 100 with a smaller parameter β exhibits a better vibration isolation performance in the z-direction.

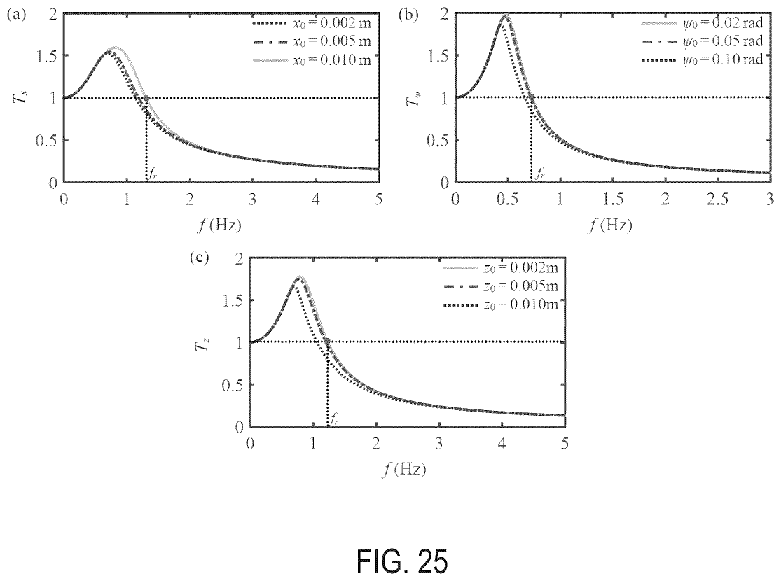

FIG. 25 shows the vibration isolation performance of the proposed vibration isolation unit 100 in the horizontal, rotational and vertical directions under different base excitation amplitudes. It is noted from FIG. 25(a) that the resonant peak increases and the resonant frequency shifts to the right slightly with the increasing base excitation amplitude x₀. However, for the displacement transmissibility of the unit in the rotational and vertical directions shown in FIGS. 25(b) and 25(c), the resonant frequency shifts to the left slightly and the resonant peak decrease with the increase of the base excitation amplitudes ψ₀ and z₀. Moreover, it can be found that when the base excitation amplitudes increase, the vibration isolation unit 100 in all three directions does not produce unstable phenomena such as jumping and bifurcation that often occur in the typical QZS vibration isolator, which is extremely beneficial to enhancing the stability of the vibration isolation unit 100. In other words, this embodiment of the vibration isolation unit 100 exhibits beneficial nonlinearities in all three directions rather than the jumping and bifurcation phenomena if the excitation amplitudes are large but in a reasonable range.

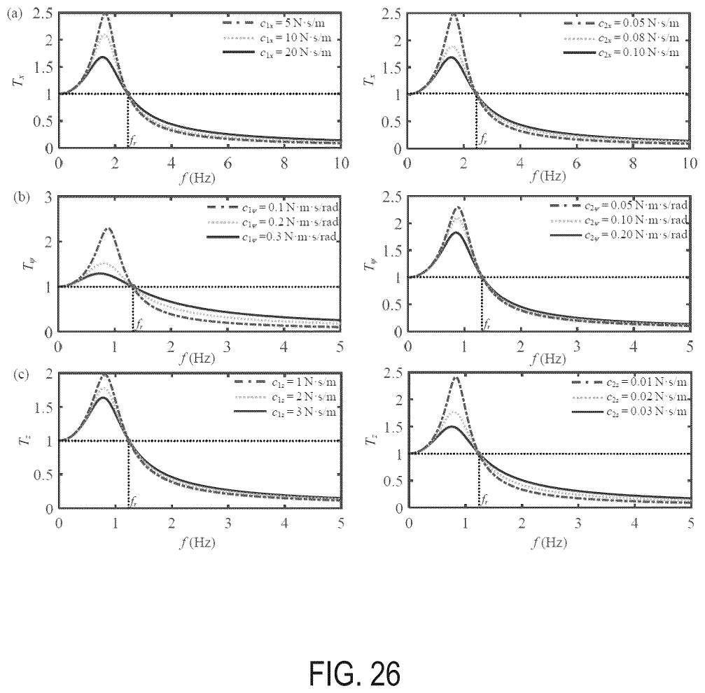

The influences of the damping coefficients on the vibration isolation performance of the unit 100 in all three directions were evaluated, and the displacement transmissibility of the vibration isolation unit 100 in the horizontal, rotational and vertical directions with different damping coefficients is displayed in FIG. 26. It is observed from FIG. 26(a) that the resonant frequency and isolation frequency of the unit 100 under different damping coefficients are all equal to 1.65 Hz and 2.45 Hz, which indicates that the change of the damping coefficient c₁ₓ or c₂ₓ has no effect on the resonant frequency and vibration isolation band of the unit 100. Additionally, the resonant peak of the unit 100 becomes lower with the increasing damping coefficient c₁ₓ or c₂ₓ, but the displacement transmissibility in the high-frequency range increases. The vibration isolation performance in the rotational and vertical directions under different damping coefficients is shown in FIGS. 26(b) and 26(c), in which the vibration isolation performance similar to the FIG. 26(a) can be maintained and increasing the damping coefficients can effectively suppress the resonant peak, but it can weaken the vibration isolation performance in the high-frequency range.

Air damping and friction of joints typically exist in the unit 100 and thus are considered when evaluating the vibration isolation performance of the vibration isolation unit 100. To strengthen the damping effect in practice, in some aspects, the vibration isolation unit 100 may include viscous dampers mounted in parallel arrangement with the springs of the unit 100 for better damping design.

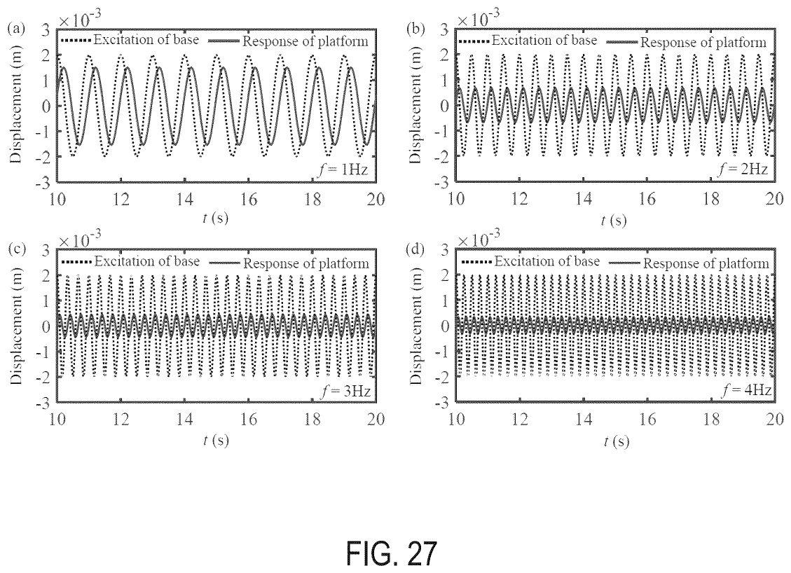

To show the vibration isolation performance more clearly, harmonic excitation at fixed frequencies of 1 Hz, 2 Hz, 3 Hz and 4 Hz and random excitation are adopted to the base member 104, and the steady-state time responses of the base member 104 and the isolation object in the vertical are calculated and shown in FIG. 27. In the calculation, the design parameters are kᵤ=400 N/m, kₘ=400 N/m, kₗ=2000 N/m, L₁=0.1 m, L₂=0.12 m, L₃=0.05 m, L₄=0.03 m, θ₁=π/3, θ₂=π/4, α=0.2, β=0.2 and zₛₜ=0.04 m. The harmonic response of the isolation object in FIG. 27 is represented by the solid line, and the harmonic excitation of the base member 104 is represented by the dotted line. It can be found from FIG. 27 that when the frequency of the harmonic excitation is equal to 1 Hz, the response amplitude of the isolation object is lower than the excitation amplitude, which demonstrates the ultra-low frequency vibration isolation performance of the vibration isolation unit 100. Moreover, when the frequency of the harmonic excitation increases to 2 Hz, 3 Hz and 4 Hz, the response amplitude of the isolation object becomes smaller. That is to say, with the frequency of the harmonic excitation increasing, the vibration isolation unit 100 exhibits better vibration isolation performance. Additionally, the response amplitude of the isolation object was found to be much lower than that of the random excitation, which further indicates the excellent vibration isolation performance of the vibration isolation unit 100.

The inventors also evaluated the high static and low dynamic stiffness characteristics and the vibration isolation performance of the unit 100 as compared with a spring-mass-damper (SMD) isolator and an existing typical QZS isolator. In the static stiffness analysis, the structural parameters of the unit 100 were L₁=0.2 m, L₂=0.25 m, L₃=0.1 m, L₄=0.06 m, kᵤ=200 N/m, kₘ=200 N/m, kₗ=1000 N/m, θ₁=π/3, θ₂=π/4 and α=β=0.2. For the typical QZS isolator, the sum of the spring stiffness was equal to that of the unit 100. Therefore, the structural parameters of the typical QZS isolator were kᵥ=200 N/m, kₕ=1200 N/m, L=0.175 m and Δh=0.014 m, and the equivalent stiffness of the vertical spring in the SMD isolator was kᵥ=200 N/m, which was the same as that of the vertical spring in the typical QZS isolator. The overall stroke of the SMD isolator, the typical QZS isolator and the unit 100 were all equal to 0.16 m. To compare the range of the QZS in the vertical direction, an indicator for evaluating the QZS characteristic was defined here, that is, when the stiffness K_{z} of the unit 100 in the vertical direction was less than 100 N/m, the corresponding region [z₀, z₁] was defined as the QZS zone.

The SMD isolator had a linear displacement and force relationship, and the stiffness remained unchanged. The working range of the QZS zone in the vertical direction of the typical QZS isolator was about 0.058 m, which is relatively small. For the unit 100, the working range of the QZS zone in the vertical direction was about 0.12 m, and the ratio of the QZS zone to the total stroke in the vertical direction was about 75%, which is much bigger than those of most typical QZS isolators. The unit 100 can also achieve QZS property in the horizontal and rotational directions, which is another advantage of the unit 100, and beneficial to achieve multi-directional low frequency vibration isolation.

Some comparisons in displacement transmissibility of the vertical direction were also conducted. To achieve the fairness of comparison, the rotational friction damping of joints in the unit 100 was not considered, and only air damping c₁=3 N·s/m is concerned for the three types of isolators. The points P₁ (z=0.05 m), P₂ (z=0) and P₃ (z=0.07 m) were chosen as the equilibria of three isolators (SMD, typical QZS, and the unit 100). The typical QZS and the unit 100 both showed the smallest stiffnesses corresponding to points P₂ and P₃. The resonant frequencies of the SMD and typical QZS isolators were 2.20 Hz and 0.41 Hz, with corresponding resonant peaks about 4.87 and 1.72. The effective vibration isolation frequency (Or was 3.15 Hz for the SMD isolator and 0.65 Hz for the typical QZS isolator. The unit 100 in the vertical direction had a resonant frequency of about 0.21 Hz, with a resonant peak of about 1.43, which were smaller than those of the SMD and QZS isolators. Moreover, the vibration isolation performance of the unit 100 in the horizontal and rotational directions included resonant frequencies less than 1 Hz. Therefore, the unit 100 can achieve ultra-low frequency vibration isolation in all three directions if needed.

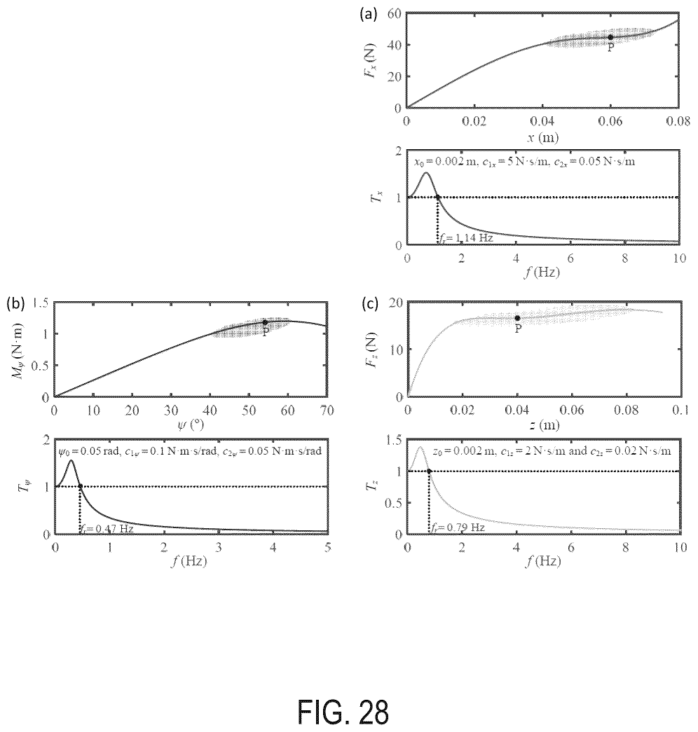

For the structural parameters kᵤ=200 N/m, kₘ=200 N/m, kₗ=1000 N/m, L₁=0.1 m, L₂=0.12 m, L₃=0.05 m, L₄=0.03 m, θ₁=π/3, θ₂=π/4, α=0.2 and β=0.2, the nonlinear force-displacement curves and vibration transmissibility of the vibration isolation unit 100 in the horizontal, rotational and vertical directions are displayed in FIGS. 28(a) to 28(c). The unit 100 can have an enhanced QZS range with large loading capacity and achieve excellent vibration isolation performance, in terms of a lower resonant frequency, a wider vibration isolation range and a lower resonant peak value in the three directions simultaneously with guaranteed stable equilibrium.

As used herein, “about,” “approximately” and “substantially” are understood to refer to numbers in a range of numerals for example the range of −10% to +10% of the referenced number, preferably −5% to +5% of the referenced number, more preferably −1% to +1% of the referenced number, most preferably −0.1% to +0.1% of the referenced number.

Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

The invention is claimed as follows:

1. A vibration isolation unit comprising:
a first base member;
a second base member;
a first support member rotatably connected to the first base member at a first joint;
a second support member rotatably connected to the first base member at a second joint, wherein the first support member crosses over the second support member at a first crossover point;
a third support member rotatably connected to the second base member at a third joint and to the first support member at a fourth joint; and
a fourth support member rotatably connected to the second base member at a fifth joint and to the second support member at a sixth joint, wherein the third support member crosses over the fourth support member at a second crossover point.

2. The vibration isolation unit of claim 1, further comprising a first resilient member having a first end rotatably connected at the fourth joint and a second end rotatably connected at the sixth joint.

3. The vibration isolation unit of claim 2, wherein the first resilient member is a spring.

4. The vibration isolation unit of claim 1, wherein each of the first, second, third, and fourth support members is a rod.

5. The vibration isolation unit of claim 1, further comprising a second resilient member having a first end rotatably connected to the second support member at a seventh joint and a second end rotatably connected to the third support member at an eight joint.

6. The vibration isolation unit of claim 5, wherein the second support member includes a first end opposite a second end, wherein the first end of the second support member includes the second joint, and wherein the second end of the second support member includes the seventh joint.

7. The vibration isolation unit of claim 6, wherein a first length of the second support member between the second and sixth joints is greater than a second length of the second support member between the six and seventh joints.

8. The vibration isolation unit of claim 5, wherein the eight joint is located on the third support member between the third joint and the second crossover point.

9. The vibration isolation unit of claim 1, further comprising a third resilient member having a first end rotatably connected to the first support member at a ninth joint and a second end rotatably connected to the fourth support member at a tenth joint.

10. The vibration isolation unit of claim 9, wherein the first support member includes a first end opposite a second end, wherein the first end of the first support member includes the first joint, and wherein the second end of the first support member includes the ninth joint.

11. The vibration isolation unit of claim 9, wherein the tenth joint is located on the fourth support member between the fifth joint and the second crossover point.

12. The vibration isolation unit of claim 1, wherein the fourth support member includes a first end opposite a second end, wherein the first end of the fourth support member includes the fifth joint, and wherein the sixth joint is located on the fourth support member between the second end of the fourth support member and the second crossover point.

13. The vibration isolation unit of claim 1, further comprising a fourth resilient member having a first end rotatably connected to the fourth support member at an eleventh joint and a second end rotatably connected to the second support member at a twelfth joint.

14. The vibration isolation unit of claim 13, wherein the twelfth joint is located on the second support member between the sixth joint and the first crossover point.

15. The vibration isolation unit of claim 13, wherein the fourth support member includes a first end opposite a second end, wherein the first end of the fourth support member includes the fifth joint, and wherein the second end of the fourth support member includes the eleventh joint.

16. The vibration isolation unit of claim 1, further comprising a fifth resilient member having a first end rotatably connected to the third support member at a thirteenth joint and a second end rotatably connected to the first support member at a fourteenth joint.

17. The vibration isolation unit of claim 16, wherein the fourteenth joint is located on the first support member between the fourth joint and the first crossover point.

18. A vibration isolation unit comprising:
a first X-shaped support structure including a first support member and a second support member;
a second X-shaped support structure including a third support member and a fourth support member, wherein the first X-shaped support structure is connected to the second X-shaped support structure at first and second rotation joints;
a first resilient member connected to each of the first and second rotation joints;
a second resilient member connecting the second support member to the third support member; and
a third resilient member connecting the first support member to the fourth support member.

19. The vibration isolation unit of claim 18, further comprising:
a fourth resilient member connecting the fourth support member to the second support member; and
a fifth resilient member connecting the third support member to the first support member.

20. The vibration isolation unit of claim 19, further comprising:
a first base member connected to the first X-shaped support structure at third and fourth rotation joints; and
a second base member connected to the second X-shaped support structure at fifth and sixth rotation joints.
